(19) United States
(12) Patent Application Publication
(10) Pub. No.: US 2014/0363287 A1
(43) Pub. Date: Dec. 11, 2014

(54) METHOD AND APPARATUS FOR WIND AND WATER POWER CONVERSION

(71) Applicant: David Joseph Talarico, Holmdel, NJ (US)

(72) Inventor: David Joseph Talarico, Holmdel, NJ (US)

(21) Appl. No.: 14/296,395

(22) Filed: Jun. 4, 2014

Related U.S. Application Data
(60) Provisional application No. 61/833,879, filed on Jun. 11, 2013.

(51) Int. Cl. F03D 9/00

(52) U.S. Cl. CPC F03D 9/00
USPC 416/1; 416/223 R

(57) ABSTRACT

The fundamental wind or water generator concept comprises one or more than one lift producing device(s), which, when subject to a wind or water current C, autonomously pivot(s) and translate(s) linearly while transmitting power to energy conversion unit (such as a pump or electric generator) by way of a flexible transmission member. The lift producing device(s) pivot(s) to a suitable angle, translate(s) a suitable distance, pivot(s) back to the original angle, and translate(s) back to its (their) starting position(s). This autonomous cycle continues indefinitely until the current's average velocity or direction changes substantially, at which point autonomous adjustments are made to accommodate the new conditions and, if possible, operation is resumed.

### CROSS-REFERENCE TO RELATED APPLICATIONS

This application claims the benefit of provisional patent application Ser. No. 61/833,879, filed 2013 Jun. 11 by the present inventor.

### BACKGROUND

### Prior Art

The following is a tabulation of some prior art that presently appears relevant:

### U.S. Patents

| Pat. No. | Kind Code | Issue Date | Patentee |
|---|---|---|---|
| 3,730,643 | B1 | May 1, 1973 | Davidson |
| 4,302,684 | B1 | Nov. 24, 1981 | Gogins |
| 4,316,361 | B1 | Feb. 23, 1982 | Hoar |
| 4,494,008 | B1 | Jan. 15, 1985 | Patton |
| 4,527,950 | B1 | Jul. 9, 1985 | Biscomb |
| 4,589,344 | B1 | May 20, 1986 | Davidson |
| 4,930,985 | B1 | Jun. 5, 1990 | Klute |
| 5,134,305 | B1 | Jul. 28, 1992 | Senehi |
| 5,758,911 | B1 | Jun. 2, 1998 | Gerhardt |
| 6,072,245 | B1 | Jun. 6, 2000 | Ockels |
| 6,489,691 | B1 | Mar. 12, 2002 | Lang |
| 6,672,522 | B2 | Jan. 6, 2004 | Lee et al. |
| 6,749,393 | B2 | Jun. 15, 2004 | Sosonkina |
| 6,992,402 | B2 | Jan. 31, 2006 | Latyshev |
| 7,075,191 | B2 | Jul. 11, 2006 | Davidson |
| 7,146,918 | B2 | Dec. 12, 2006 | Meller |
| 7,902,684 | B2 | Mar. 8, 2011 | Davidson et al. |

### U.S. Patent Application Publications

| Publication Nr. | Kind Code | Publ. Date | Applicant |
|---|---|---|---|
| 0001393 | A1 | Jan. 2, 2003 | Staikos et al. |
| 0176430 | A1 | Aug. 2, 2007 | Hammig |
| 0030361 | A1 | Feb. 10, 2011 | Gopalswamy et al. |
| 0088382 | A1 | Apr. 21, 2011 | Berthilsson |
| 0202407 | A1 | Aug. 8, 2013 | Dumas et al. |

Finding cleaner ways to generate electrical power is a top priority of the developed world. Besides being limited in supply, fossil fuels emit carbon dioxide as well as other toxic gases when used. Renewable energy sources offer a more appealing solution as they do not have the same issues as fossil fuels. However, these energy sources often have a higher cost per unit energy than fossil fuels do.

Wind and water power are two of the most well established examples of renewable energy. These sources offer a nearly unlimited source of energy. Furthermore, the devices used in these industries have a considerably lower impact on the environment.

The design that dominates the wind power industry is the three-blade horizontal axis wind turbine (HAWT). HAWT wind farms typically require that the individual turbines be spaced thousands of feet apart to prevent the wake of one turbine from detrimentally affecting the performance of another.

Another problem with the HAWT design is that the tips of the blades reach speeds nearing the speed of sound, making them a loud annoyance to local residents. Many also consider the design to be an eyesore. This forces wind farms to be constructed in remote areas far from where the power is needed. The long transmission lines from the wind farms to the load greatly increase losses in the line and therefore decrease overall efficiency.

Due to the rotary nature of the design, the tip of each blade travels at a much higher speed than the root. Thus, to maintain uniform stresses along the length of the blades, they are designed with a complex twist and taper. Such an intricate geometry has proven to be tremendously difficult to manufacture, being that one blade can be as long as a football field, leaving designers no other option than to have it manufactured by hand laying fiberglass. Such a process lets surface imperfections go unnoticed and leads to failure rates as high as 20%.

In the literature, several technologies have been proposed for converting energy from a wind or water current into another form. Many of these machines comprise tracks with long continuous chains of wings or sails. Examples include U.S. Pat. No. 3,730,643, U.S. Pat. No. 4,302,684, U.S. Pat. No. 4,494,008, U.S. Pat. No. 4,527,950, U.S. Pat. No. 4,589,344, U.S. Pat. No. 4,930,985 U.S. Pat. No. 5,134,305, U.S. Pat. No. 5,758,911, U.S. Pat. No. 6,672,522, U.S. Pat. No. 6,992,402, U.S. Pat. No. 7,075,191, U.S. Pat. No. 7,146,918, U.S. Pat. No. 7,902,684, and US 2003/0001393. One problem with this type of technology is that adjusting to changing wind direction can be complicated or impossible. Another problem with many of these designs is that the support structures would have to be to be bulky and expensive to withstand high winds or rapids in stormy conditions.

The main problem with all of these designs is that they are not cost competitive with fossil fuels.

### SUMMARY

In accordance with one embodiment a power conversion apparatus comprises a linearly translating lift producing device that can provide useful work.

### Advantages

Accordingly, advantages of one or more aspects are as follows: to provide power conversion apparatuses that are more cost efficient, that may be placed closer together without a significant loss of performance, that operate more quietly, that are more visually appealing, that are easier to manufacture, that can readily adapt to changing wind or water direction, and that can readily adapt to rapidly changing wind or water current speeds. Other advantages of one or more aspects will be apparent from a consideration of the drawings and ensuing description.

### BRIEF DESCRIPTION OF THE DRAWINGS

FIG. 1A is a perspective view of a wind or water powered generator.

FIG. 1B is a sectional view of the wind or water powered generator from FIG. 1A.

FIG. 1C is a cut away view of a normally engaged disc lock.

FIG. 1D is a sectional view of a spring loaded piston cylinder type damper in the refracted position.

FIG. 1E is a sectional view of a spring loaded piston cylinder type damper in the extended position.

FIG. 1F shows an enlarged view of an electromechanical flow aligner from the same wind or water powered generator from FIG. 1A, which has been reoriented to provide sufficient detail.

FIG. 1G is a perspective view of an end frame corresponding to the wind or water powered generator shown in FIG. 1A

FIG. 1H is a sectional view of a two way translation to one way rotation mechanism.

FIG. 1I is a schematic showing a top view of a wind or water powered generator subject to a specific flow direction.

FIG. 1J is a schematic showing a top view of a wind or water powered generator subject to a specific flow direction.

FIG. 1K is a schematic showing a top view of a wind or water powered generator subject to a specific flow direction.

FIG. 1L is a flowchart that represents an algorithm that could be used to control a wind or water powered generator.

FIG. 1M is a flowchart representing a flow alignment function.

FIG. 1N is a flowchart representing a sail adjustment function.

FIG. 1O is a diagram that illustrates the flow directions which are suitable for energy harnessing.

FIG. 2A is a perspective view of a wind or water powered generator with a plurality of sails.

FIG. 2B is an enlarged view of a two way translation to one way rotation mechanism and routing pulleys.

FIG. 3 is a perspective view of a wind or water powered generator whose guides are flexible members.

FIG. 4A is a perspective view of a wind or water powered generator whose frame rotates to accommodate varying flow direction.

FIG. 4B is a perspective view of an end frame corresponding to the wind or water powered generator shown in FIG. 4A.

FIG. 4C is a sectional view of the wind or water powered generator from FIG. 4A.

FIG. 4D is a sectional view of a one way locking mechanism.

FIG. 4E is an enlarged view of an alternately gripping mechanism.

FIG. 5A is a perspective view of a wind or water powered generator that can accommodate a flow that is substantially parallel to one direction.

FIG. 5B is a perspective view of an alternately gripping mechanism.

FIG. 5C is a sectional view of an alternately gripping mechanism.

FIG. 6 is a perspective view of a wind or water powered generator that adjusts to flow direction about an axis parallel to the direction of translation of its sail car.

### DETAILED DESCRIPTION OF A PLURALITY OF EMBODIMENTS

While the present disclosure may be susceptible to embodiment in different forms, the figures show, and herein described in detail, embodiments with the understanding that the present descriptions are to be considered exemplifications of the principles of the disclosure and are not intended to be exhaustive or to limit the disclosure to the details of construction and the arrangements of components set forth in the following description or illustrated in the figures.

This disclosure includes a new way to harness energy from wind or water current and convert it into another form.

### Fundamental Concept:

The fundamental wind or water generator concept comprises one or more than one lift producing device(s), which, when subject to a wind or water current C, autonomously pivot(s) and translate(s) linearly while transmitting power to energy conversion unit (such as a pump or electric generator) by way of a flexible transmission member. The lift producing device(s) pivot(s) to a suitable angle, translate(s) a suitable distance, pivot(s) back to the original angle, and translate(s) back to its (their) starting position(s). This autonomous cycle continues indefinitely until the current's average velocity or direction changes substantially, at which point autonomous adjustments are made to accommodate the new conditions and, if possible, operation is resumed.

Throughout the following description, the lift producing device is depicted and described as a sail. This is considered to be exemplary, and it should be understood that any suitably large and efficient lift producing device may be used.

The described embodiments will be best understood by reference to the drawings, wherein like parts are designated with like numerals throughout.

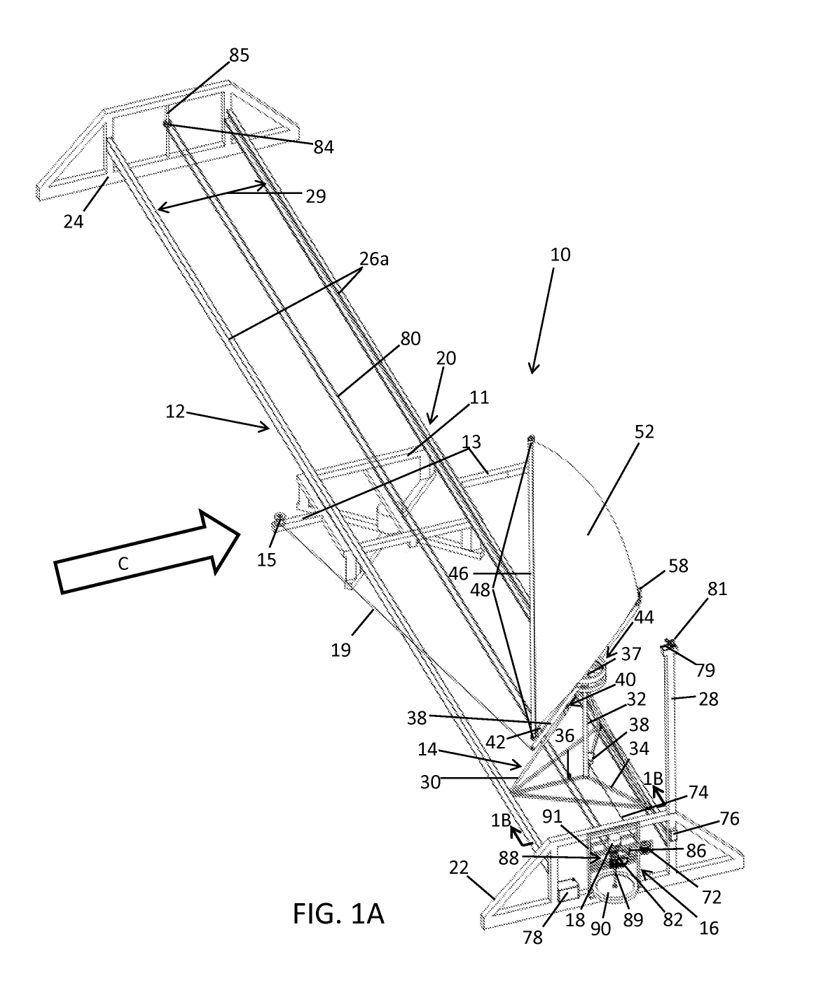

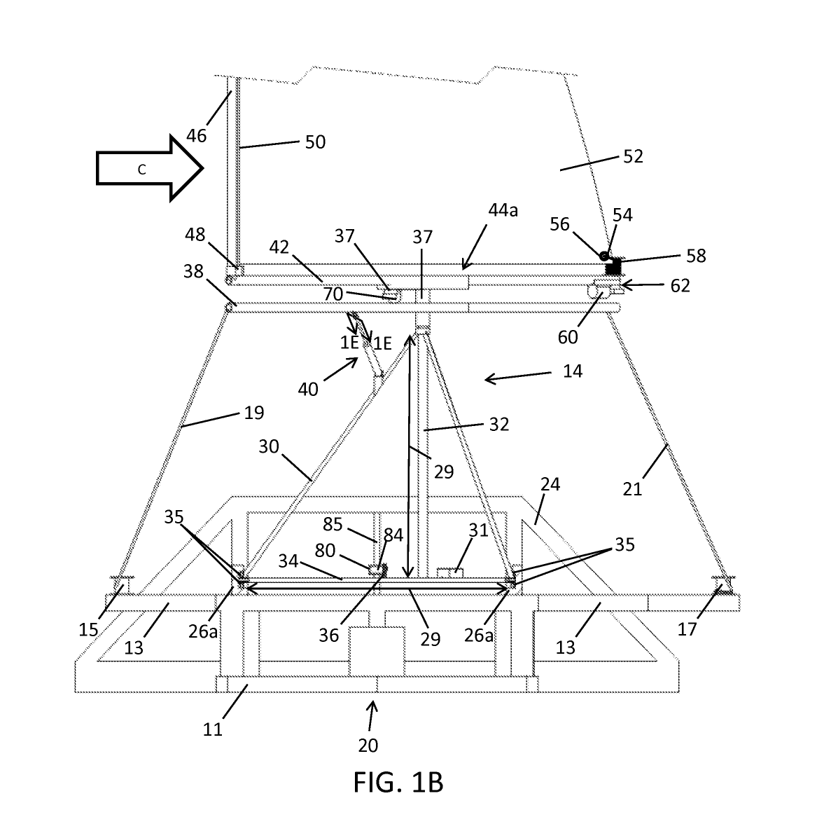

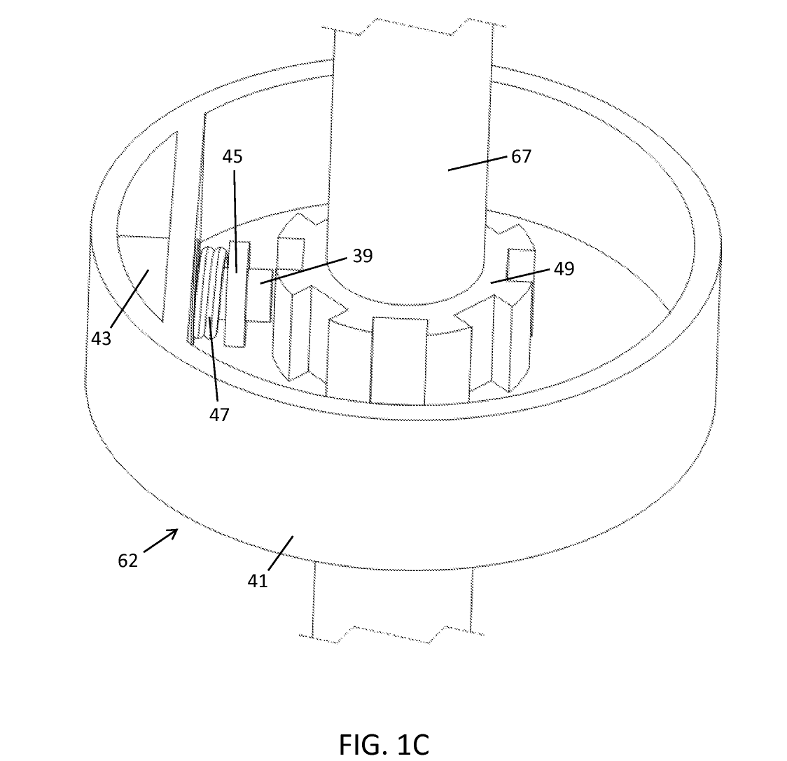

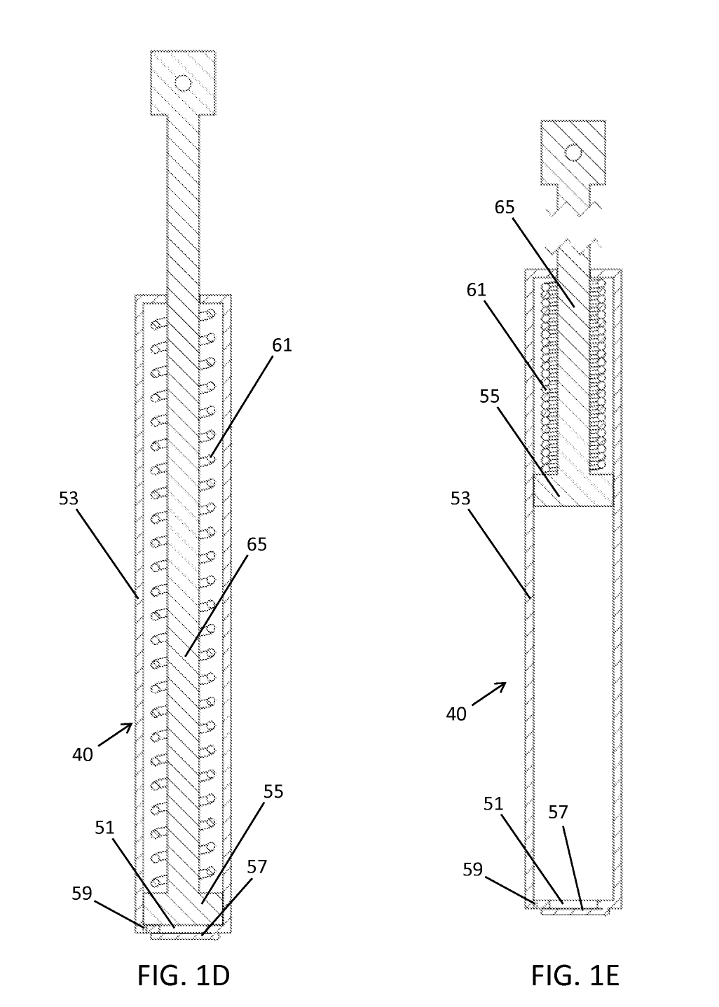

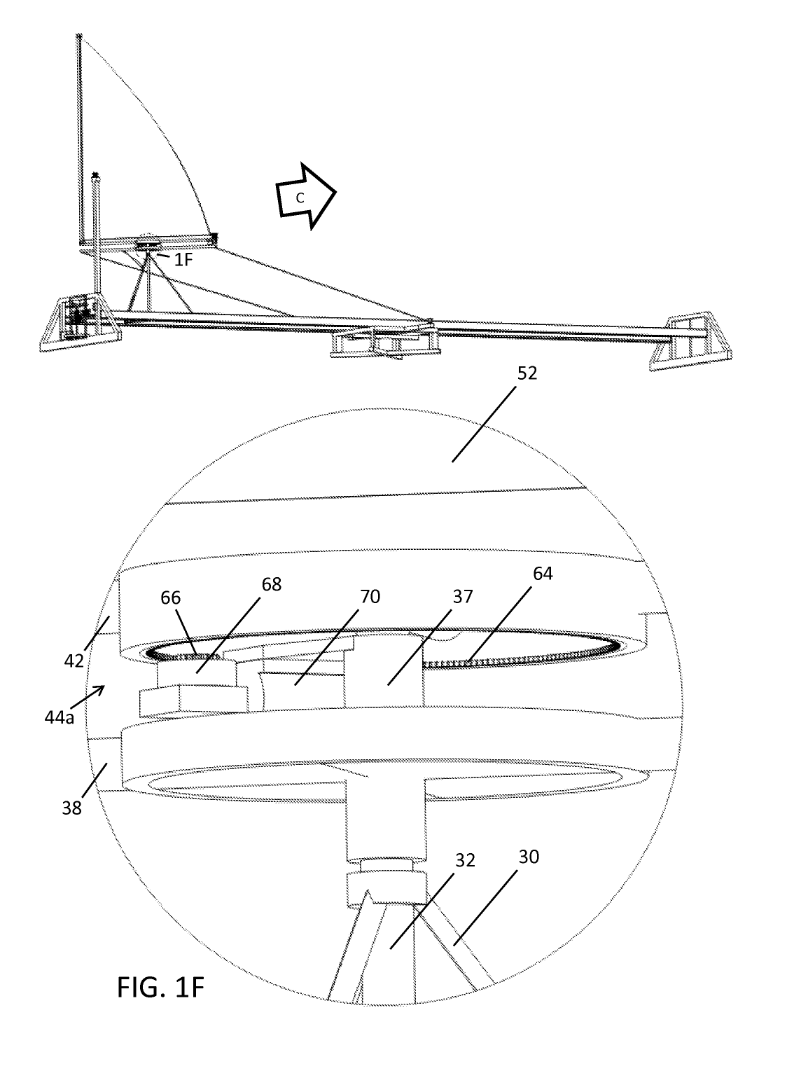

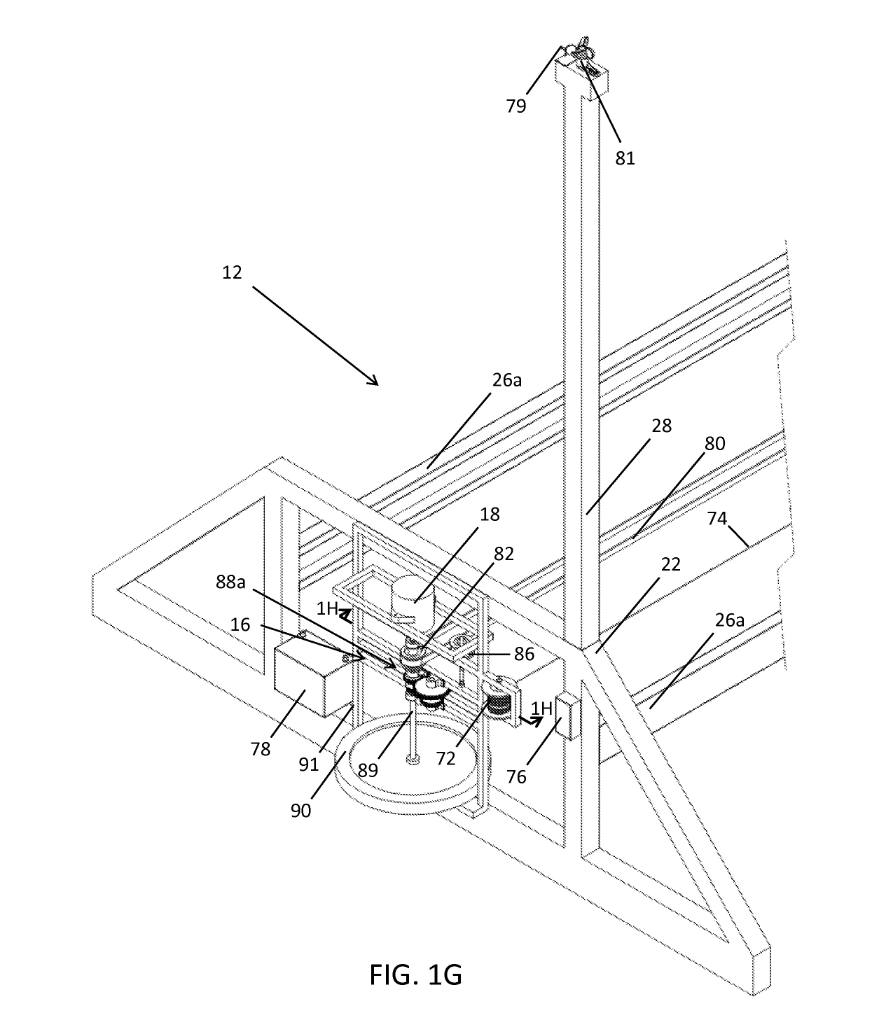

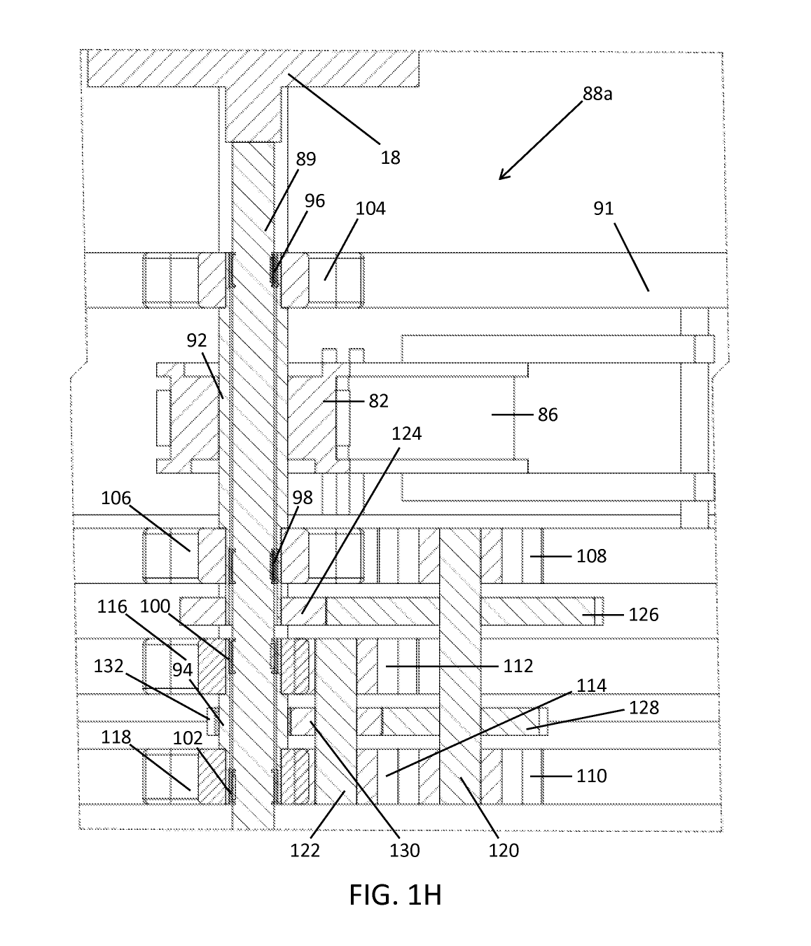

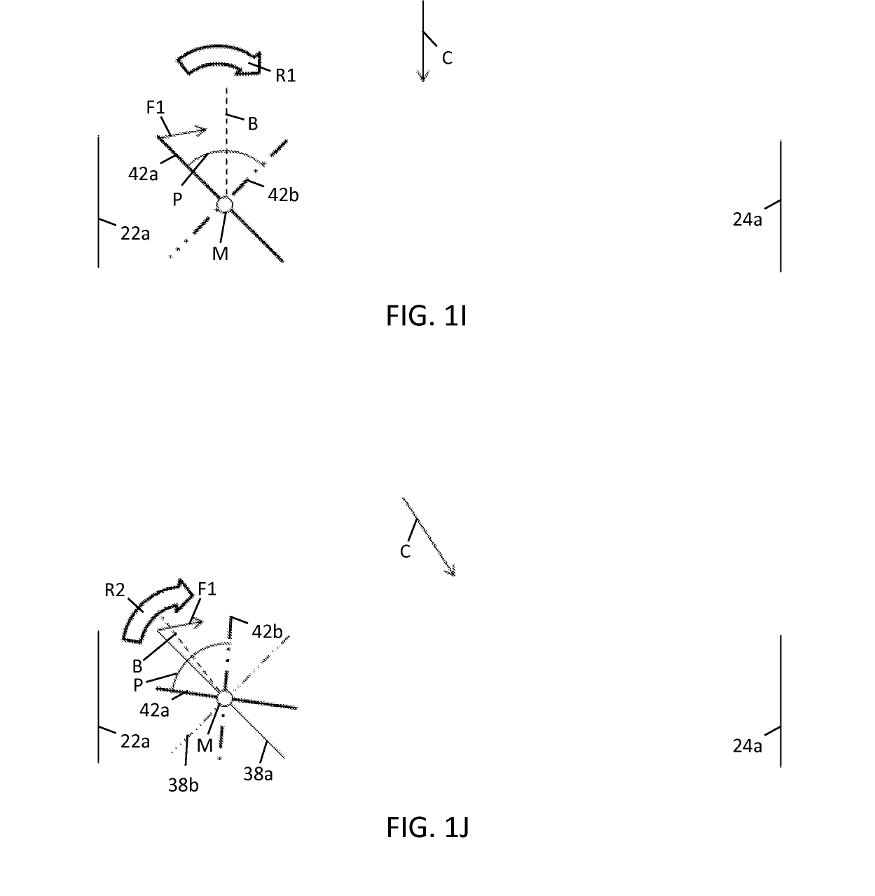

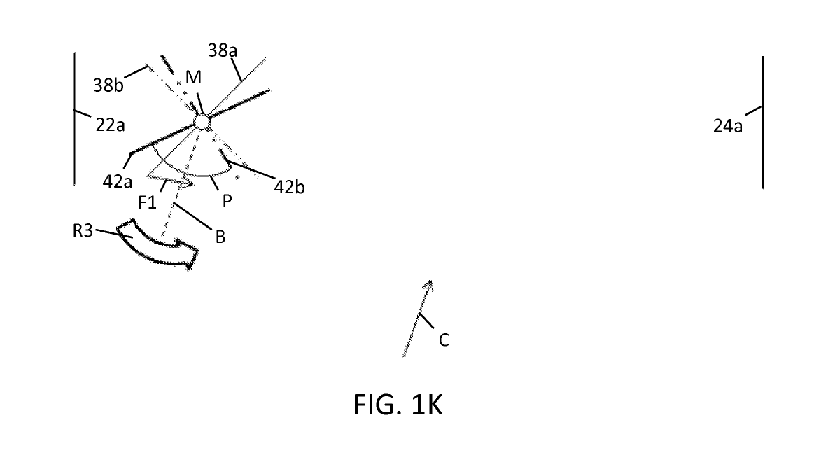

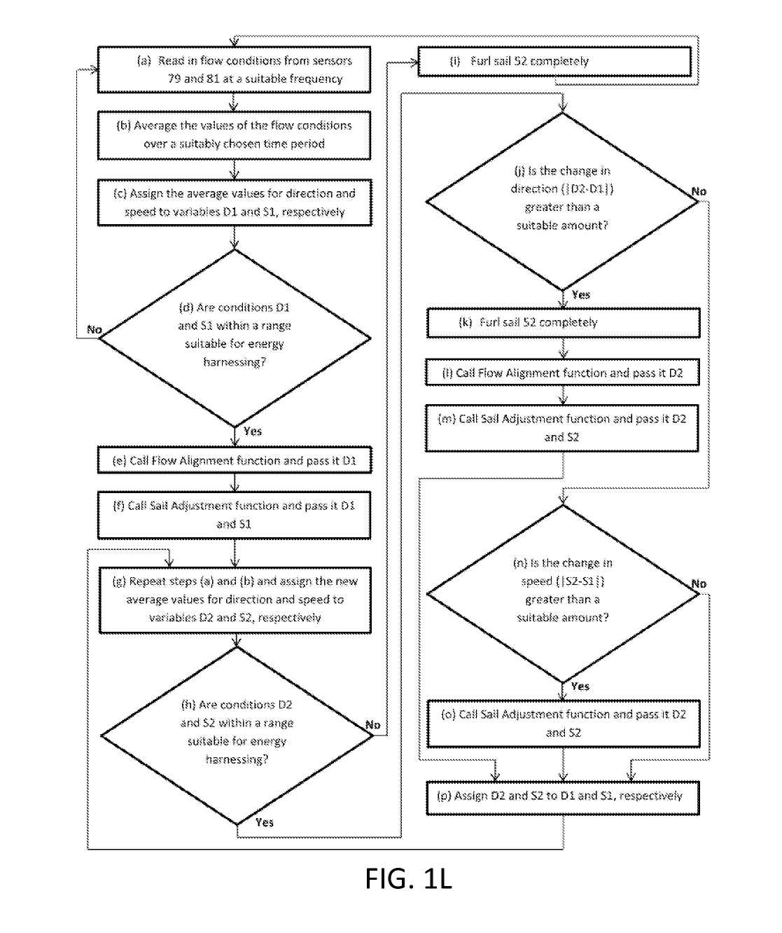

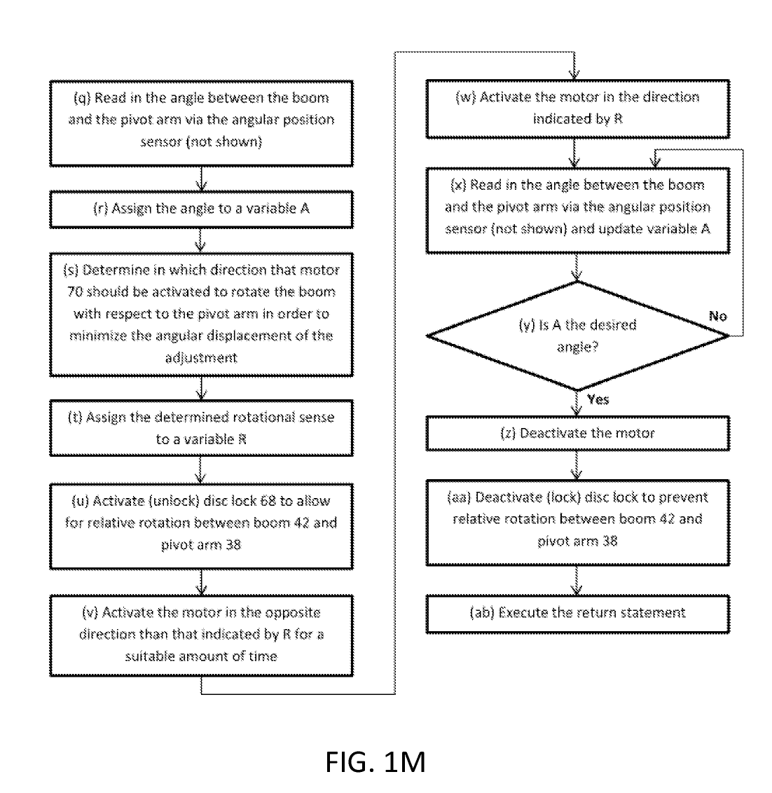

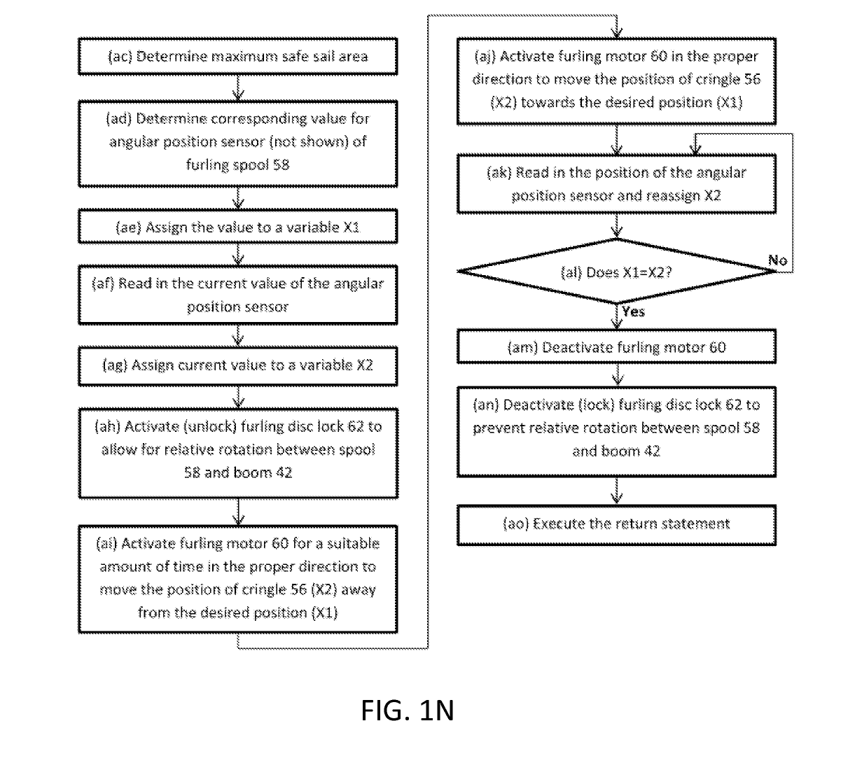

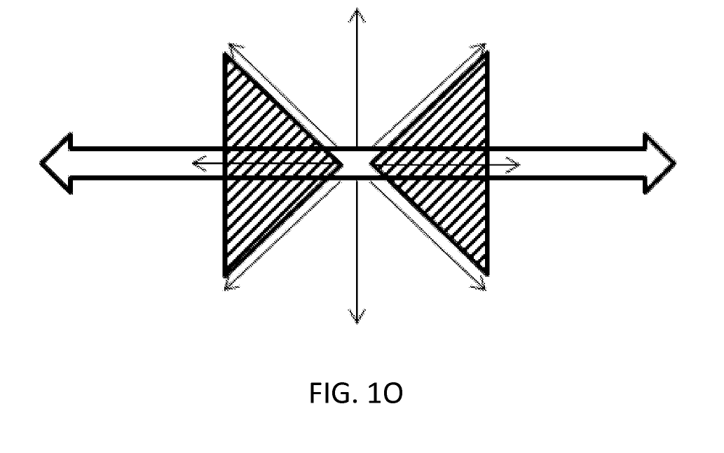

### FIG. 1A—Perspective View of a Wind or Water Powered Generator

One embodiment of the fundamental wind or water generator concept, generally designated 10, is illustrated in FIG. 1A-FIG. 1H. As shown in FIG. 1A, the generator apparatus comprises a frame 12, a sail car 14, a transmission 16, an electric generator 18, and an angle reversal frame 20. A sail 52 is shown just before it pivots.

In one embodiment, frame 12 comprises two end frames 22 and 24 which are joined by zero, one, or more than one substantially linear, parallel guide(s) 26a and an instrument pole 28 which protrudes vertically from end frame 22. The frame may also contain structural members (not shown) that connect, in a way that leaves all moving parts of generator 10 unobstructed, the track segments to each other at regular intervals along the length of the track segments to act in a similar manner as railroad ties. One or more than one of these structural members may be supported by a structure that is fixed relative to the ground or by a suitably moored buoy. In one embodiment, frame 12 is made of pressure treated lumber. However, the frame can consist of one or more than one suitably strong, weather resistant material(s) such as pressure treated wood, painted or stainless steel, aluminum, high strength plastic, rubber, concrete, cement, brick, fiberglass, composites, and the like.

One embodiment of the fundamental wind or water generator concept may be suitably mounted to the earth or to a man-made structure to harness wind and/or water flow energy. Other embodiments of the concept may comprise a suitable amount of attached floatation (not shown) and may be suitably moored in a body of water to harness wind and/or water flow energy. Such an embodiment's sail car (not shown) may include attached water skis (not shown) or pontoons (not shown). Other embodiments of the concept may be mounted by any suitable means on or near the bottom of a body of water to harness water flow energy.

### FIG. 1A and FIG. 1B—Description of an Angle Reversal Frame

In one embodiment, shown in FIG. 1A and FIG. 1B, angle reversal frame 20 comprises a base 11, two beams 13, two coil spring type recoiling spools 15 and 17, and two flexible taught members 19 and 21. The base is fixed to the undersides of guides 26a near their midpoint lengthwise. Beams 13 extend horizontally outward in opposite directions and are substantially perpendicular to guides 26a. Spools 15 and 17 are rotatably mounted near the end of each beam and are connected to members 19 and 21 respectively. In one embodiment, an eye bolt (not shown) is mounted vertically to each beam at a suitable height in front of each spool to guide its respective member.

The recoiling function of the spools keeps members 19 and 21 from interfering with sail car 14 as it translates. In one embodiment, the members are made of standard elastic shock cord, but they may be made of any sufficiently durable flexible material such as rubber rope, latex tubing, nylon rope, urethane belting, steel or aluminum solid or braided cable(s), any type of line, any type of natural or synthetic fibrous solid or braided rope(s), any type of belt(s) (reinforced or not), any type of fabric(s), and the like.

Depending on the direction of current C, either member 19 or member 21 applies a force to sail car 14 sufficient to change the angle that sail 52 makes with the direction of current C. In the state shown in FIG. 1A and FIG. 1B, member 19 is applying a force on sail car 14 and member 21 is not. Note from FIG. 1B that part of member 21 is still wrapped around spool 17, indicating that member 21 is not being utilized while current C is moving in the direction shown.

### FIG. 1B—Description of Linear Guide(s)

In one embodiment, as shown in FIG. 1B, guides 26a are rigid and have inward facing concave cross sections. However, the track sections may have any suitably strong cross section to counter act downward, lifting, and horizontal forces to which they will be subject. A sufficiently small width 29 between guides 26a should be chosen such that the weight of sail car 14 is suitably small yet not so small as to cause excessive stress that could damage any part of generator 10 as it is subject to wind or water forces.

### FIG. 1A and FIG. 1B—Description of a Sail Car

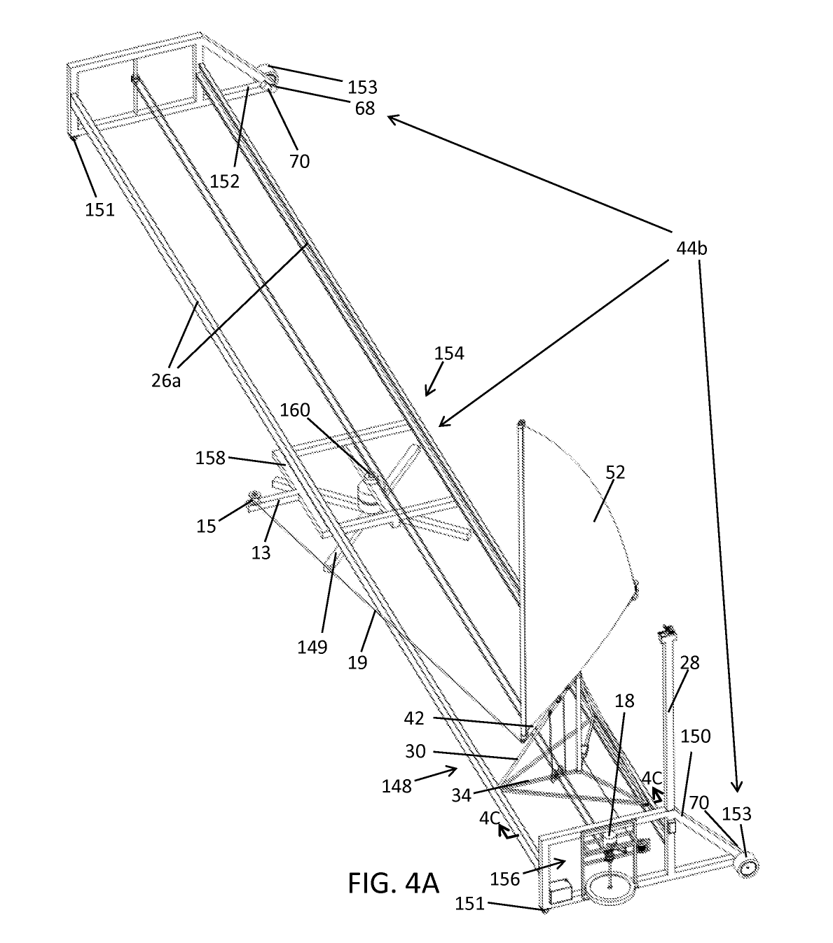

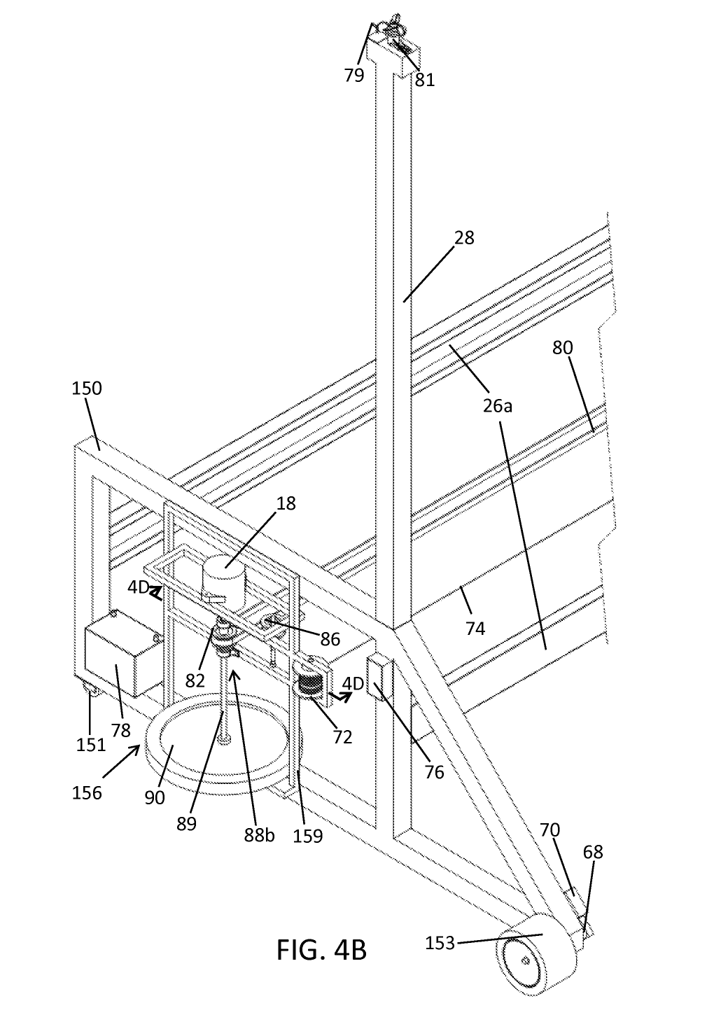

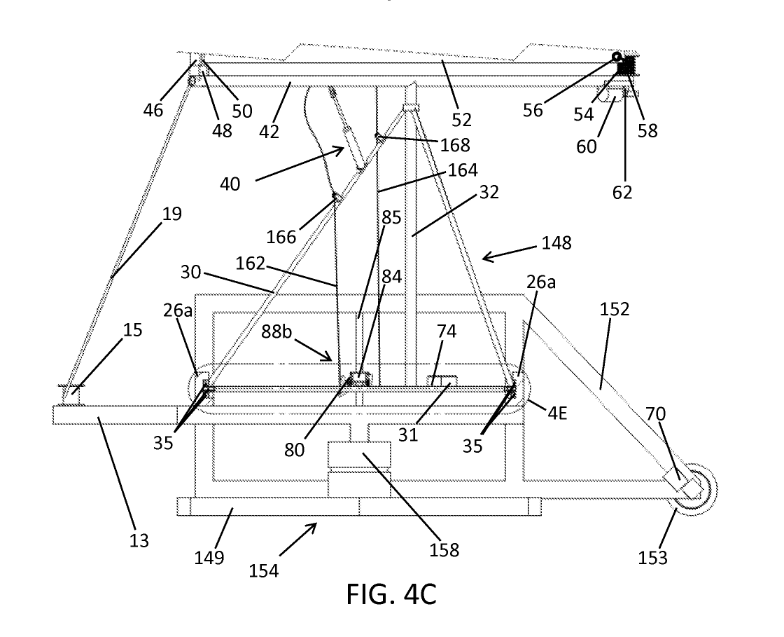

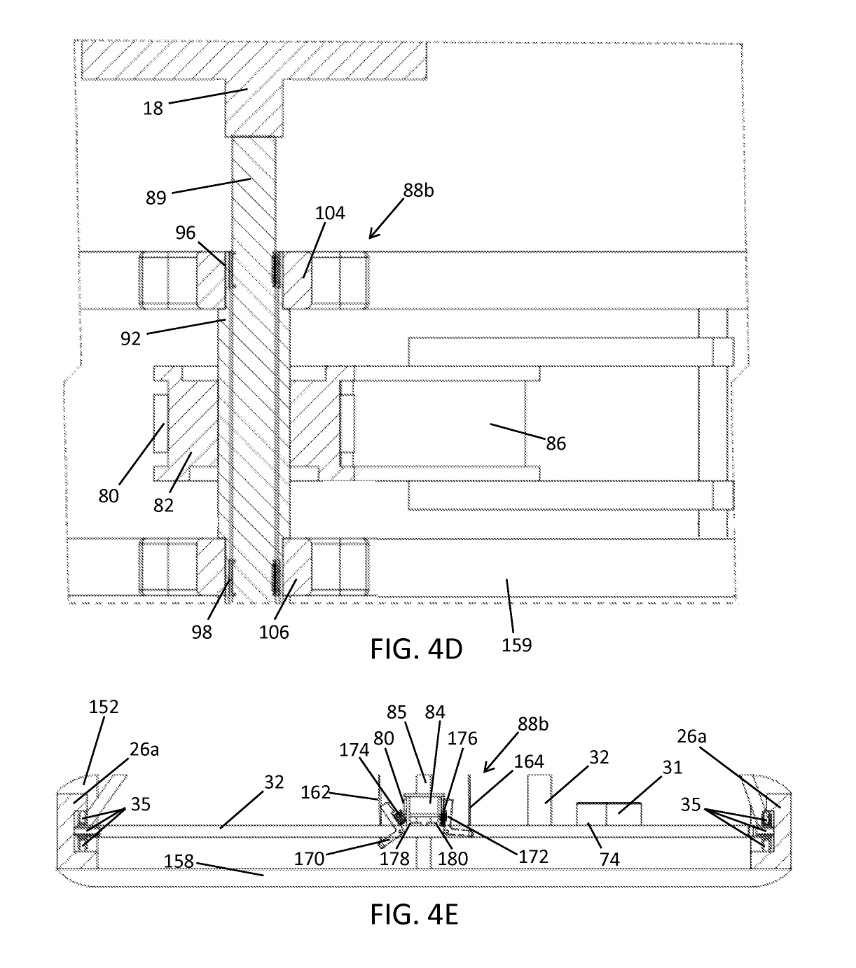

Sail car 14, shown in FIG. 1A and more clearly in FIG. 1B, includes a car frame 30 on which is rotatably supported an upright mast axle 32. In one embodiment, car frame 30 is a regular tetrahedron with cross bracing at the base, but any geometry could be chosen so long as a sufficiently large span 33 of mast axle 32 would be suitably supported. At the base 34 of car frame 30, adjacent to guides 26a, a plurality of wheels 35 counteract downward, lifting, and horizontal forces to which sail car 14 will be subject (An additional detailed view of wheels 35 is shown in FIG. 4C). A clamp 36 and a car electrical box 31 are mounted to the upper surface of base 34. The clamp couples and allows power transmission from sail car 14 to transmission 16.

Above car frame 30 on mast axle 32, a horizontal pivot arm 38 is mounted near its center to a pivot sleeve 37 which is rotatably mounted to the mast axle. Pivot arm 38 autonomously rotates and locks into place relative to the mast axle when the direction of current C changes. The upper end of mast axle 32 is suitably connected to a location along a horizontal boom 42 such that current C holds damper 40 in its fully extended position when the boom is properly aligned relative to the current direction. Boom 42 is coupled to pivot arm 38 by an electromechanical flow aligner 44a (described later). In one embodiment, best seen from FIG. 1B, the horizontal distance from spool 15 to one end of pivot arm 38 is substantially equal to the horizontal distance from spool 17 to the other end of pivot arm 38. A damper 40 is rotatably mounted to car frame 30 at one end and rotatably mounted to a pivot arm 38 at its other end such that, during a pivot, it gently stops the rotation of the pivot arm from exceeding a suitable angle.

In one embodiment, a plurality of protrusions (not shown) that extend vertically from end frames 22 and 24 may replace or supplement angle reversal members 19 and 21 by interfering with the upwind/upstream end of pivot arm 38 and thereby causing sail 52 to pivot.

A mast 46 protrudes vertically from the upwind/upstream end of boom 42. In one embodiment, car frame 30 is made of square and triangular aluminum tubing and mast axle 32, pivot arm 38, boom 42, and mast 46 are made of circular aluminum tubing. However, the car frame, mast axle, pivot arm, boom, and mast may consist of one or more than one suitably strong, lightweight, weather resistant material(s) such as aluminum, carbon fiber, painted steel, titanium, fiberglass, and the like, and of any suitable lightweight cross section(s). Standard vibrational analysis should be conducted to determine geometries for all structural components of wind or water powered generator 10 such that the components should have have natural resonant frequencies that are substantially dissimilar to the frequencies likely to be encountered in and/or caused by the natural environment.

One or more than one coil spring type sail recoiler(s) 48 of suitable stiffness is (are) fixed to mast 46. A luff extrusion 50 is rotatably mounted to sail recoiler(s) 48. Luff extrusion 50 is fixed by any suitable method to the luff of substantially triangular sail 52 such that the coil spring (not shown) inside sail recoiler(s) 48 is (are) wound (loaded) as the sail is unfurled from the luff extrusion. In other embodiments, the sail recoiler(s) may be mounted inside or around the mast, and/or the basic shape of sail 52 may be that of a rectangle, a trapezoid, a genoa, a spinnaker, a gennakker, and the like. In one embodiment, the center of rotation of sail 52 can be autonomously adjusted by any suitable electro-mechanical means. In one embodiment, one or more than one advertisement, logo, company name, message, or design is (are) printed on sail 52 for commercial, aesthetic, or personal purposes. In one embodiment, clamp 36 is connected to a point on mast 46 that lies on the same horizontal plane as the center of pressure of sail 52 when the sail is unfurled a suitable amount such that the stresses in the sail's support structure are suitably small by virtue of smaller moments caused by the flow acting on the sail.

A member 54 is attached at one end to a furling spool 58 and at its other end to a sail cringle 56 that is placed near the downwind/downstream corner of sail 52. In one embodiment, member 54 is a braided steel cable, but it may be made of any sufficiently durable flexible material such as rubber rope, latex tubing, nylon rope, steel or aluminum solid or braided cable(s), any type of line, any type of natural or synthetic fibrous solid or braided rope(s), any type of belt(s) (reinforced or not), any type of fabric(s), and the like.

A furling motor 60 is mounted near the downwind/downstream end of boom 42. Its shaft (not shown) is fixed to the disc of a normally engaged furling disc lock 62 (whose casing is fixed relative to boom 42) and to furling spool 58 such that activating the furling disc lock 62 allows a furling motor shaft 67 and connected spool 58 to spin freely. Spool 58 contains a suitably precise angular position sensor (not shown) that references boom 42 and allows the position of cringle 56 and thus the exposed area of sail 52 to be deduced. The sensor outputs a unique value for each of a suitable number of positions which are spaced substantially evenly over the entire range of possible positions that cringle 56 can have with respect to boom 42. To power motor 60 and to power and receive data from the angular position sensor, one or more than one electric wire detangler(s) (not shown) is (are) located between pivot sleeve 37 and mast axle 32. In one embodiment, a standard electric mainsail furling system is used in place of recoiler(s) 48, member 54, furling motor 60, sail cringle 56, furling disc lock 62, and luff extrusion 50.

### FIG. 1C—Description of a Disc Lock

One embodiment of normally engaged disc lock 62, shown electrically activated, mechanically disengaged, and with view obstructing components removed in FIG. 1C, comprises a circular casing 41, a standard pull-type solenoid 43 (which contains a pin 39), a flange 45, a compression-type spring 47, and a notched disc 49. Casing 41 houses the components and is typically fixed to a nearby frame by any suitable means. Solenoid 43 is fixed to the inside of casing 41 near the edge and aligned with a diameter of the casing. Disc 49 is fixed to furling motor shaft 67. Flange 45 is fixed an appropriate distance along pin 39 of solenoid 43 to constrain spring 47 in a way that forces pin 39 into a notch 63 of disc 49 when solenoid 43 is deactivated. When the solenoid is activated, pin 39 is actuated by the solenoid such that it is pulled towards the edge of the casing and out of notch 63. A normally disengaged disc lock may look identical to the mechanism shown in FIG. 1C, but the spring (not shown) would be an extension type (pulling) and the solenoid (not shown) would be push type. Disc lock 62 therefore provides an automated means for locking and unlocking.

In one embodiment, shown in FIG. 1C, furling disc lock 62 alleviates the torque which holds sail 52 in a partially or fully unfurled position in order to prevent this torque from damaging the furling motor. However, it may be the case here or anywhere else within this disclosure (unless otherwise stated) that alternative embodiments substitute a given motor for a motor that is, for example, a stepper motor or a worm and pinion drive motor whose holding torque is large enough to withstand the torques to which it will be subject. No disc lock for use in conjunction with such a motor would be needed.

### FIG. 1B—Description of Furling System

In other embodiments, in order to reduce the mass moment of inertia of the furling motor with respect to the mast axle, the furling motor may be placed closer to mast axle 32 and a pulley (not shown) may be placed at the downwind/downstream end of the boom to facilitate unfurling.

Furling spool 58 contains a torque limiting mechanism (not shown) that allows furling spool 58 to freely rotate with respect to the furling motor's shaft when the force applied to member 54 exceeds a threshold set to prevent damage to any part of generator 10.

If the speed of current C exceeds a safe amount, thereby permitting furling spool 58 to rotate freely by exceeding its torque limiting mechanism's threshold, sail recoiler(s) 48 will begin to furl sail 52 to reduce its effective area. This reduction of sail area reduces the force on the sail and prevents any damage to generator apparatus 10. Additionally, if the force acting on the sail by the current exceeds a suitable amount, the same furling process may be triggered by activating (unlocking) disc lock 62 and utilizing furling motor 60 in a first rotational sense. At suitable times, disc lock 62 may be unlocked and furling motor 60 may be activated in the opposite rotational sense to unfurl sail 52 and increase sail area. In one embodiment, a mechanical fuse (not shown) is spliced into line member 54 that acts as a second fail-safe to prevent the transmission of any large and possibly destructive forces.

### FIG. 1D and FIG. 1E—Description of Damper

In one embodiment, shown in sectional views FIG. 1D and FIG. 1E, damper 40 is a spring loaded piston-cylinder unit with an opening 51 near one end of a cylinder 53 that is sufficiently large to provide little to no resistance to the motion of a piston 55. A piston rod 65 is attached to piston 55 at one end and is attached pivotally to pivot arm 38 (FIG. 1A and FIG. 1B) at its other end. Any suitable means are used to ensure a substantial seal between cylinder 53 and piston 55 and a fluid passage between piston rod 65 and cylinder 53. FIG. 1D shows the piston just before it extends and FIG. 1E shows the piston just after it extended. Located near the end of cylinder 55 and sealing opening 51 there is a one way valve 57 that remains open to allow a fluid to flow freely through it during the retraction of a piston 59. During the extension of the piston, one way valve 57 closes and a sufficiently small hole 59 located near the same end as the one way valve provides resistance to gently bring mast axle 32 (FIG. 1A and FIG. 1B) to a stop while it pivots. A spring 61 is located between piston 55 and cylinder 53 such that energy is stored and released in the spring during the extension and refraction of the piston, respectively. The spring thereby facilitates both the angular acceleration of the mast axle during the retraction of the piston and the angular deceleration of the mast axle during the extension of the piston. In one embodiment, the length of piston rod 65 is autonomously adjusted by any suitable electro-mechanical means. In one embodiment, the length of cylinder 53 is autonomously adjusted by any suitable electro-mechanical means.

### FIG. 1A, FIG. 1B, and FIG. 1F—Description of Flow Aligner

In one embodiment, shown in FIG. 1A and FIG. 1B and most clearly in FIG. 1F, electromechanical flow aligner 44a comprises a flow alignment motor 70 that is fixed to pivot sleeve 37, a normally engaged disc lock 68, and an externally toothed spur or pinion gear 66 meshed with an internally toothed ring gear 64 that is fixed to an end of mast axle 32 above car frame 30. Other embodiments may have other methods of controlling the angle between the pivot arm 38 and boom 42 to adapt to a change in the direction of current C. Examples include but are not limited to a worm and pinion drive (not shown), a direct drive (not shown), a belt drive (not shown), a chain drive (not shown), any electro-mechanical means, and the like. In one embodiment, direction adjustment motor 70 contains a suitably precise angular position sensor (not shown). The sensor outputs a unique value for each of a suitable number of positions which are spaced substantially evenly over the entire range of possible angles that the upwind/upstream end of boom 42 makes with the upwind/upstream end of pivot arm 38. In other embodiments, an angular position sensor may be located adjacent to mast axle 32 and pivot sleeve 37 or in disc lock 68.

### FIG. 1A and FIG. 1G—Description of the Parts Supported by an End Frame

In one embodiment, shown in FIG. 1A and FIG. 1G, end frame 22, in addition to supporting transmission 16, electric generator 18, instrument pole 28, and guides 26a, also supports a coil spring type electric cable retractor 72, an electric cable 74, a control box 76, and a battery 78. Electric cable 74 is attached to car electrical box 31 (FIG. 1A and FIG. 1B) at one end and to electric cable retractor 72 at its other end. Electric cable 74 and electric cable refractor 72 allow power and/or data to be transferred between frame 12 and sail car 14 (FIG. 1A and FIG. 1B) without interfering with the motion of the sail car. In one embodiment, the electric cable retractor contains an angular displacement sensor (not shown). This sensor may be used to track the position of sail car 14 (FIG. 1A and FIG. 1B). In one embodiment, suitable waterproofing and/or fairing-type weather proof covering(s) are used to protect electrical, structural, and/or mechanical components where such (a) covering(s) is(are) suitable.

### FIG. 1G—Description of an Instrument Pole and a Control Box

In one embodiment, shown most clearly in FIG. 1G, instrument pole 28 supports a flow direction sensor 79 and a flow speed sensor 81. Both of these sensors send information about the flow conditions of current C to electronic hardware (not shown) located in control box 76.

Control box 76 may contain any suitable electronic hardware to allow an operator to override the automated process that carries on during normal operation. In one embodiment, it contains an array of LEDs (not shown) which allows an operator to view current and/or recorded data.

### FIG. 1G—Description of Viable Energy Conversion and Storage

Battery 78 is shown as an example of an energy storage device and/or a power supply for the field coil (not shown) of electric generator 18. In other embodiments, the electric generator may not have a field coil and/or the use of a battery may not be suitable. Electric generator 18 may be wired to any suitable energy storage device/system or directly to the electric grid in any suitable manner. In one embodiment, a pump (not shown) is used in place of an electric generator to allow for energy storage in the form of a pressurized (or elevated) fluid and/or to supply electrical energy and/or water for municipal and/or agricultural purposes.

In one embodiment, a semi-rigid fluid filled hose (not shown) is mounted to the inner surface of linear guide(s) 26a. The hose is compressed by one or more than one wheel(s) 35 (FIG. 1A and FIG. 1B), creating a linear peristaltic pump. This pump may be implemented in conjunction with a network of one way valves that act as diodes do in a standard full wave rectifier to both replace transmission 16 and electric generator 18 and to allow for energy storage in the form of a pressurized (or elevated) fluid and/or to supply electrical energy and/or water for municipal and/or agricultural purposes.

### FIG. 1G and FIG. 1H—Description of a Transmission

In one embodiment, mostly shown in FIG. 1G and FIG. 1H, transmission 16 comprises a suitably chosen drive pulley 82, an opposing idler pulley 84 (shown in FIG. 1A), a spring loaded tensioner 86, a two way translation to one way rotation converter 88a, a flywheel shaft 89, a flywheel 90, and a frame 91. A flexible transmission member 80 is fixed to clamp 36 and couples sail car 14 to transmission 16. In one embodiment, member 80 is a belt made of reinforced polyurethane, but it may be made of any sufficiently durable flexible material such as rubber rope, latex tubing, nylon rope, steel or aluminum solid or braided cable(s), any type of line, any type of natural or synthetic fibrous solid or braided rope(s), any type of belt(s) (reinforced or not), any type of fabric(s), and the like.

In one embodiment, a manned sailboat (not shown) that replaces frame 12 (FIG. 1A), sail car 14(FIG. 1A and FIG. 1B), transmission 16, and angle reversal frame 20 (FIG. 1A) is fixed to member 80 and transmits power to a land-based end frame 22, where end frame 24 is supported by a suitably moored buoy.

Tensioner 86 applies a force to member 80 to keep it taught around pulleys 82 and 84 while it is driven by sail car 14. In one embodiment, sail car 14 is fixed to member 80; consequently, member 80 drives pulley 82 clockwise when sail car 14 is moving in one direction, and counterclockwise when sail car 14 is moving in the other direction. Converter 88a allows the two way rotation of pulley 82 to drive flywheel shaft 89 in a single direction. Flywheel shaft 89 is coupled to flywheel 90 at one end and to electric generator 18 at the other end. The motion of sail car 14 may be intermittent at times due to inherent intermittencies such as: (a) changes in the speed of current C, (b) the sail car pivoting and changing direction, (c) adjustments made to the sail car, and the like. Flywheel 90 sufficiently reduces this inherent intermittency to provide a substantially constant rate of rotation to electric generator 18. In one embodiment, a standard electronically controlled continuously variable transmission (not shown) is used in place of pulley 82 to autonomously optimize the electrical power output of electric generator 18. In one embodiment, a plurality of chain-driven sprockets (not shown) and an electronically controlled derailleur (not shown) are used between converter 88 and flywheel shaft 89 to autonomously optimize the electrical power output of electric generator 18. In one embodiment, one or more than one suitable electro-mechanical brake(s) is (are) used to better control the angular speed of flywheel shaft 89.

In one embodiment, a suitably chosen constant force spring is used in place of flywheel 90 to reduce the inherent intermittency to provide a substantially constant rate of rotation to electric generator 18.

### FIG. 1A—Location of Idler Pulley

Referring back to FIG. 1A, pulley 84 is rotatably mounted on a substantially vertical shaft 85, which is in turn mounted to end frame 24 such that member 80 is substantially parallel to guides 26a.

### FIG. 1H—Description of a Two Way Translation to One Way Rotation Converter

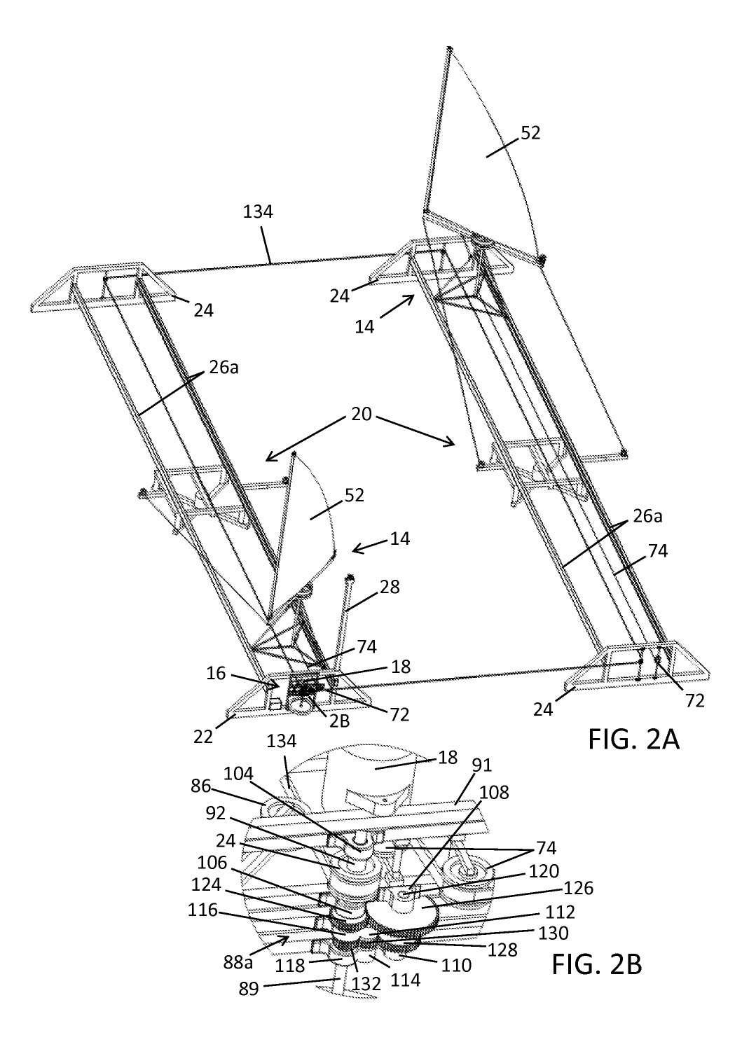

In one embodiment, shown in full in sectional view FIGS. 1H and 1n part in enlarged view FIG. 2B, two way translation to one way rotation converter 88a comprises two shafts 92 and 94 which are concentric about flywheel shaft 89, one way clutches 96, 98, 100, and 102, pillow block supports 104, 106, 108, 110, 112, 114, 116, and 118, shafts 120 and 122, and gears 124, 126, 128, 130, and 132. Shaft 92 houses clutches 96 and 98 and is rotatably journaled at its ends to supports 104 and 106. Pulley 82 is fixed near the middle of shaft 92. Gear 124 is fixed to one end of shaft 92 and is meshed with gear 126. Shaft 120 is fixed to gears 126 and 128 and is rotatably journaled near its ends to supports 108 and 110. Gear 128 is meshed with gear 130. Shaft 122 is fixed to gear 130 and is rotatably journaled at its ends to supports 112 and 114. Gear 132 is fixed to shaft 94 and is meshed with gear 130. Shaft 94 houses clutches 100 and 102 and is rotatably journaled in supports 116 and 118. In one embodiment, various materials, coatings, and lubricants suitable for the conditions to which a given component may be subject to in a given environment are used. In one embodiment, converter 88a is suitably encased and lubricated.

By virtue of the gear arrangement, shaft 94 rotates with the same rotational speed but with the opposite rotational sense of shaft 92. When shaft 92 is driven by pulley 82 in a first rotational sense, clutches 96 and 98 engage to transmit power to flywheel shaft 89 and clutches 100 and 102 disengage to allow shaft 94 to rotate freely about the flywheel shaft. When shaft 92 is driven by pulley 82 in the opposite rotational sense, clutches 100 and 102 may engage to transmit power to flywheel shaft 89, while clutches 96 and 98 disengage to allow shaft 92 to rotate freely about the flywheel shaft. Gears 124, 126, 128, 130, and 132 should be selected such that one rotation of gear 124 results in one rotation of gear 132. When shaft 92 is not being driven by pulley 82, clutches 96, 98, 100, and 102 disengage to allow the flywheel shaft to rotate freely inside shafts 92 and 94. This way, no power can be transmitted back from the flywheel to the sail car.

Other embodiments of a two way translation to one way rotation converters may include any standard two way to one way rotation mechanisms.

### Operation of First Embodiment

### FIG. 1A

During normal operation (shown in FIG. 1A), current C is harnessed by sail 52, causing sail car 14 to translate linearly along guides 26a. When sail car 14 comes sufficiently close to either end frame 22 or 24, either member 19 or 21 (depending on the direction of current C) will apply a force to an end of pivot arm 38 causing sail 52 to pivot and translate linearly in the opposite direction. Sail car 14 is fixed to member 80, allowing the motion of sail car 14 to supply power to transmission 16.

FIG. 1I-1K (with reference to FIG. 1A and FIG. 1B)

As you read the following three paragraphs, reference FIG. 1A and/or FIG. 1B as needed. In all three examples, note that boom 42 maintains a substantially equal angular relationship with the direction of current C, and that pivot arm 38 maintains a substantially equal angular relationship with end frames 22 and 24.

FIG. 1I shows a simplified overhead sketch of wind or water generator 10 shown as boom 42 pivots through an angle P. A block arrow R1 illustrates the direction of rotation of boom 42. A solid line 42a represents the position of the boom just before it pivots and a phantom line (dot-dot-dash) 42b represents the position of the boom just after it pivots. A dashed line B bisects the angle that boom 42 pivots through. For efficient operation, bisector B should remain substantially parallel to the mean flow direction of current C (the average being taken over a suitable amount of time). A circle M represents the center of rotation of boom 42. An arrow F1 represents the pivoting force exerted on pivot arm 38 (which is collinear with the boom and therefore is hidden from view) by member 19. Two solid lines 22a and 24a represent end frames 22 and 24, respectively.

FIG. 1J shows a similar situation as FIG. 1I, but the flow direction is at a different angle and the proper adjustment has been made via electromechanical flow aligner 44. Note that boom 42 pivots though the same angle P and that bisector B remains substantially parallel to the direction of current C. A block arrow R2 illustrates the direction of rotation of boom 42. A thin solid line 38a represents pivot arm 38 just before it pivots, and a phantom line 38b represents pivot arm 38 just after it pivots. An arrow F2 represents the pivoting force exerted on pivot arm 38 by member 19. Note that while flow energy is being harnessed (and thus electromechanical flow aligner 44 is inactive), boom 42 and pivot arm 38 do not rotate with respect to one another, thus they pivot together. Also note that the position and direction of force F2 are the same as those of force F1 in FIG. 1I.

FIG. 1K shows a similar situation as FIG. 1I, but the flow direction is at another different angle and the proper adjustment has been made via electromechanical flow aligner 44. Note that boom 42 pivots though the same angle P and that bisector B remains substantially parallel to the direction of current C. A block arrow R3 illustrates the direction of rotation of boom 42. In FIG. 1I and FIG. 1J, member 19 acted on one end of pivot arm 38 to cause it to pivot. However, the direction of current C in FIG. 1K is such that member 21 acts on the opposite end of pivot arm 38 to cause it to pivot with the opposite rotational sense. An arrow F3 represents the pivoting force exerted on pivot arm 38 by member 21. Member 21 is utilized to pivot instead of member 19 here simply because the end of the pivot arm that member 21 is connected to is further from spool 17 than the other end of the pivot arm is from spool 15. Therefore, member 21 is completely unwound from spool 17 while member 19 is still partially coiled around spool 15. The opposite was true in FIG. 1I and FIG. 1J.

### FIG. 1L-1N—Description of a Computer Program

One embodiment includes a computer program, one example of such a program is illustrated by the flowcharts in FIG. 1L, FIG. 1M, and FIG. 1N which are loaded onto suitably chosen electronic hardware (not shown) in order to automate the adjustment of wind or water generator 10 as it is subject to varying flow conditions.

### Step (a)

The program begins with a step (a), which reads in the direction and speed of current C from direction sensor 79 and speed sensor 81, respectively.

### Step (b)

A step (b) takes the average of a suitable number of direction readings, and it takes the average of a suitable number of speed readings.

### Step (c)

A step (c) assigns the average direction to a variable D1 of suitable type and precision and the average speed to a variable S1 of suitable type and precision.

### Step (d)

A step (d) assesses the feasibility of energy harnessing given the conditions D1 and S1. Energy harnessing will be deemed feasible if the average flow speed is great enough to harness energy with sufficient efficiency without being so great that the flow causes damage to wind or water generator 10. If energy harnessing is not feasible, the program will return to step (a) to assess the new flow conditions.

This loop (steps (a) through (d)) continues until the conditions (D1 and S1) permit energy harnessing, at which time the program will go to a wind alignment step (e) to adjust to the flow direction.

### Step (e)

A step (e) calls a flow alignment function that aligns boom 42 with the direction of current C. This function is passed the variable D1 and has no return type.

### FIG. 1M—Flow Alignment Function

### Step (q)

In one embodiment, illustrated by a flowchart in FIG. 1M, a flow alignment function begins with a step (q) that reads in the angle between the boom and the pivot arm via the angular position sensor (not shown) that is contained within direction adjustment motor 70.

### Step (r)

A step (r) assigns the angle between the boom and the pivot arm to a variable A of suitable type and precision.

### Step (s)

Next, a step (s) then determines in which direction that motor 70 should be activated (to rotate the boom with respect to the pivot arm) such that the angular displacement of the adjustment is as small as possible.

### Step (t)

A step (t) assigns the rotational sense to a Boolean variable R such that “true” represents a first rotational sense and “false” represents the opposite rotational sense.

### Step (u)

A step (u) electrically activates (mechanically unlocks) disc lock 68 to allow for relative rotation between boom 42 and pivot arm 38.

### Step (v)

A step (v) activates motor 70 in the opposite rotational sense than that indicated by R to encourage the pin (not shown) of disc lock 68 (an example of a similar disc lock is illustrated in FIG. 1C) to disengage from the adjacent notch (not shown) in the disk (not shown) of disk lock 68. Motor 70 should be activated here for just enough time to allow the pin to disengage from the adjacent notch.

### Step (w)

Next, a step (w) activates the motor in the direction indicated by R.

### Step (x)

A step (x) then reads in the angle between the boom and the pivot arm via the angular position sensor (not shown) contained within motor 70 and updates variable A by assigning it the new reading.

### Step (y)

A step (y) determines whether or not variable A is the desired value. Referring to FIG. 1I-1K, the desired value of A corresponds to the parallel alignment of bisector B and the flow direction D1, in which case the angle between the boom and the pivot arm would be substantially equal to the difference between the angle corresponding to D1 and the angle corresponding to the direction of current C shown in FIG. 1I. If the value of A is not the desired value, the program goes to step (x). The loop (step(x)-step(y)) should iterate at a sufficiently high frequency so that each possible discrete value that can be assigned to variable A during the adjustment is assigned at least once. The loop continues until variable A is the desired value, at which time the program moves to a step (z).

### Step (z)

A step (z) deactivates motor 70.

### Step (aa)

A step (aa) electrically deactivates (mechanically locks) disc lock 68 to prevent relative rotation between boom 42 and pivot arm 38.

### Step (ab)

A step (ab) executes the return statement. This terminates the execution of the function and returns control to the calling function.

### Step (f)

Referring back to FIG. 1L, a step (f) calls a sail adjustment function that unfurls an area of sail 52 that is suitable for the conditions represented by D1 and S1.

### FIG. 1N—Sail Adjustment Function

### Step (ac)

In one embodiment, illustrated by a flowchart in FIG. 1N, a sail adjustment function begins with a step (ac), which determines the maximum safe sail area based on the values passed to it for flow direction and speed.

### Step (ad)

To review, sail 52 can be unfurled by drawing cringle 56 closer to furling spool 58 by winding member 54 around spool 58. A step (ad) determines the value of the angular position sensor of spool 58 that corresponds to the unfurling of the sail area found in step (ac).

### Step (ae)

A step (ae) assigns the value found in step (ad) to a variable X1 of suitable type.

### Step (af)

A step (af) reads in the current value of the angular position sensor of spool 58.

### Step (ag)

A step (ag) assigns the value found in step (af) to a variable X2.

### Step (ah)

A step (ah) electrically activates (mechanically unlocks) furling disc lock 62 to allow for relative rotation between spool 58 and boom 42.

### Step (ai)

A step (ai) activates furling motor 60 for a suitable amount of time in the proper direction to move the position of cringle 56 away from the desired position to encourage pin 39 of disc lock 62 (shown in detail in FIG. 1C) to disengage from the adjacent notch 63 in the disk 49 of disk lock 62. Motor 60 should be activated here for just enough time to allow the pin to disengage from the adjacent notch.

### Step (aj)

A step (aj) activates furling motor 60 in the proper direction to move the position of cringle 56 towards the desired position or, equivalently, to make the value of X2 approach X1.

### Step (ak)

Step (ak) reads in the position of the angular position sensor and reassigns X2.

A step (al) checks to see if X1 now equals X2. If X1 does not equal X2, the program goes to step (aj). This loop (step (ai)-step (aj)) iterates at a suitable frequency until X1 equals X2, at which time the program goes to a step (ak).

### Step (am)

A step (am) deactivates furling motor 60.

### Step (an)

A step (an) electrically deactivates (mechanically locks) furling disc lock 62 to prevent relative rotation between spool 58 and boom 42.

### Step (ao)

A step (ao) executes the return statement. This terminates the execution of the function and returns control to the calling function.

### Step (g)

Referring back to FIG. 1L, a step (g) repeats step (a) and step (b) and assigns the new average value for direction to a suitably chosen type of variable D2 and the new average value for speed to a suitably chosen type of variable S2.

### Step (h)

A step (h) determines if the flow conditions D2 and S2 are within a range that is suitable for energy harnessing. If they are not within a suitable range, the program goes to a step (i). If they are within a suitable range, the program goes to a step (j).

### Step (i)

Step (i) furls sail 52 completely and directs the program to step (a).

### Step (j)

Step (j) determines if the change in direction or, equivalently, the absolute value of the difference of D1 and D2 is greater than a suitable amount. The optimal allowable difference (which may differ based on geographical location) should be small enough to keep bisector B substantially parallel to the flow direction without being so small that insignificant changes in flow direction frequently interrupts the operation of wind or water generator 10. If the change is greater, the program goes to a step (k). If the change is not greater, the program goes to a step (n).

### Step (k)

Step (k) furls sail 52 completely.

### Step (l)

A step (l) calls the Flow Alignment Function and passes it D2.

### Step (m)

A step (m) calls the Sail Adjustment Function, passes it D2 and S2, and subsequently directs the program to a step (p).

### Step (n)

A step (n) determines if the change in speed or, equivalently, the absolute value of the difference of S1 and S2 is greater than a suitable amount. The optimal allowable difference should be small enough to keep the flow from damaging wind or water powered generator 10 without being so small that insignificant changes in flow speed frequently interrupts the operation of wind or water generator 10. If the change is greater, the program goes to a step (k). If the change is not greater, the program goes to a step (n).

### Step (o)

A step (o) calls the Sail Adjustment Function and passes it D2 and S2.

### Step (p)

A step (p) assigns the value of D2 to the variable D1, assigns the value of S2 to the variable S1, and subsequently directs the programs to step (g).

### FIG. 1O—Diagram of Flow Directions for Energy Harnessing

FIG. 1O is a simple diagram that illustrates the flow directions which are suitable for energy harnessing. The horizontal block arrow indicates the directions which sail car 14, from an embodiment in FIG. 1A, travels. The line arrows represent all of the possible directions of current C. The two hatched triangles represent an example of the range of directions which are not suitable for energy harnessing. When the flow is moving in any of these directions, the sail car will not be able to translate, as very little or no forces will propel it in the direction of its linear guides 26a. In sailing, the range of directions which a sailboat cannot travel with respect to the wind direction is known as the no-go zone.

### FIG. 2A—Perspective View of a Wind or Water Powered Generator

One embodiment, shown in FIG. 2A, of the fundamental wind or water generator concept comprises: a plurality of translating sail cars 14, end frames 24, substantially parallel guides 26a, angle reversal frames 20, electric cable retractors 72, electric cables 74, one end frame 22, one instrument pole 28, one transmission 16, and one electric generator 18. Sails 52 are shown just before they pivot.

Sail cars 14 are connected at locations along a suitably routed flexible transmission member 134 such that at least one sail car's back and forth cycle remains 180 degrees out of phase with the rest. In one embodiment, member 134 is a belt made of reinforced polyurethane, but it may be made of any sufficiently durable flexible material such as rubber rope, latex tubing, nylon rope, steel or aluminum solid or braided cable(s), any type of line, any type of natural or synthetic fibrous solid or braided rope(s), any type of belt(s) (reinforced or not), any type of fabric(s), and the like.

By virtue of this arrangement, the no-go zone illustrated in FIG. 1O is substantially reduced, because at least one sail which is traveling with the flow when the directions of translation of the sail cars are nearly parallel to the flow direction. This one sail pulls the other(s) while it (they) is (are) unable to propel itself (themselves).

Electric cable retractors 72 are rotatably mounted near the center of end frame 22 and one end frame 24. In one embodiment, a flexible positioning member (not shown), suitably strung around a plurality of pulleys (not shown), is used to constrain the (relative) position of (a plurality of) sail car(s) 14. In one embodiment, an angular position and/or angular velocity sensor in one of the pulleys of such a positioning member is installed such that the position and/or velocity and/or acceleration of one or more than one sail car(s) attached to the positioning member may be deduced. In one embodiment, a motor of suitable torque in conjunction with a pulley and a positioning member is installed in such a way that the motor may be activated to aid in the pivot of sail(s) 52 in the event of a stall in the operation of a wind or water powered generator due to a lack of sufficient momentum of sail car(s) 14.

### FIG. 2B—Description of Routing Pulleys

In one embodiment, shown in FIG. 2B, member 134 is kept suitably coupled to transmission 16 via routing pulleys 137.

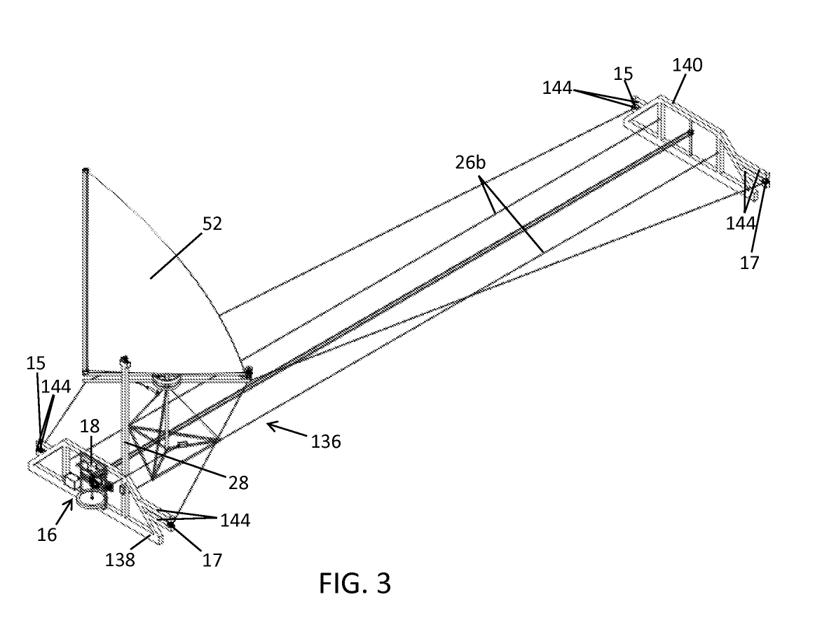

### FIG. 3—Perspective View of a Wind or Water Powered Generator

One embodiment, shown in FIG. 3, of the fundamental wind or water generator concept comprises a cable sail car 136, angle reversal end frames 138 and 140, substantially parallel guides 26b (shown in FIG. 3 as flexible members in tension), one instrument pole 28, one transmission 16, and one electric generator 18. Sail 52 is shown just before it pivots.

Angle reversal end frames 138 and 140 are identical to end frames 22 and 24, respectively, except for the addition of horizontal protrusions 144 which support spools 15 and 17.

Cable sail car 136 is identical to sail car 14 except: (i) it has no wheels 35, and (ii) it has suitably sized and tapered holes 146 that members 26b are strung through to counteract downward, lifting, and horizontal forces to which cable sail car 136 will be subject. In other embodiments, holes 146 may be replaced with a plurality of suitable guide rollers, wheels, and/or pulleys. In one embodiment, a suitable low friction coating such as PTFE is used to reduce the friction between wheels 35 and guides 26a between tapered holes 146 and members 26b.

In one embodiment, guides 26b are made of braided steel cables, but they may be made of any sufficiently durable flexible material such as nylon rope, steel or aluminum solid or braided cable(s), any type of line, any type of natural or synthetic fibrous solid or braided rope(s), any type of belt(s) (reinforced or not), any type of fabric(s), and the like.

### FIG. 4A—Perspective View of a Wind or Water Powered Generator

One embodiment, shown in FIG. 4A, of the fundamental wind or water generator concept comprises one sail car 148, two end frames 150 and 152, substantially parallel guides 26a, an angle reversal frame 154, one instrument pole 28, a transmission 156, an electromechanical flow aligner 44b, and one electric generator 18. Sail 52 is shown just before it pivots.

In one embodiment, electromechanical flow aligner 44b comprises end frames 150 and 152, which are supported by casters 151 and drive wheels 153. Drive wheels 153 are fixed to the end of axles (not shown), which are, in turn, substantially horizontal and properly journaled near the bottom of the downstream/downwind ends of end frames 150 and 152. The other ends of the axles (not shown) are fixed to the discs (not shown) of normally engaged disc locks 68 (FIG. 4B) and to flow alignment motors 70.

### FIG. 4A and FIG. 4C—Description of an Angle Reversal Frame

In one embodiment, shown in FIG. 4A and FIG. 4C, angle reversal frame 154 comprises a fixed base 149, a rotatable support 158, a detangler 160, one beam 13, one coil spring type recoiling spool 15, and one flexible taught member 19. Beam 13, spool 15, and member 19 maintain identical connectivity and functionality as in embodiments in FIG. 1A and FIG. 1B, except beam 13 now protrudes from support 158 instead of base 11. Support 158 is rotatably mounted to base 149 at one end and is fixed to the undersides of guides 26a near their midpoint lengthwise at its other end. In one embodiment, an eye bolt (not shown) is mounted vertically to beam 13 at a suitable height in front of spool 15 to guide member 19. In one embodiment, a circular track (not shown) replaces rotatable support 158 by constraining casters 151 and drive wheels 153.

### FIG. 4C—Description of a Sail Car

In one embodiment, shown in FIG. 4A and more clearly in FIG. 4C, sail car 148 comprises the following parts that maintain identical function in FIG. 1A and FIG. 1B: car frame 30, mast axle 32, wheels 35, car electrical box 31, damper 40, boom 42, mast 46, sail recoiler(s) 48, luff extrusion 50, sail 52, member 54, furling spool 58, sail cringle 56, furling motor 60, and furling disc lock 62. These parts maintain identical connectivity as in FIG. 1A and FIG. 1B except that damper 40 is rotatably mounted to car frame 30 at one end and rotatably mounted to boom 42 at its other end such that it gently stops the rotation of the boom from exceeding a suitable angle.

### FIG. 4A and FIG. 4B—Description of the Parts Supported by an End Frame

In one embodiment, shown in FIG. 4A and FIG. 4B, end frame 150 supports transmission 156, electric generator 18, instrument pole 28, guides 26, coil spring type electric cable refractor 72, electric cable 74, control box 76, and battery 78. Electric cable 74 is attached to car electrical box 31 at one end and to electric cable retractor 72 at the other end. Electric cable 74 and electric cable retractor 72 allow power and/or data to be transferred between frame 12 and sail car 14 without interfering with the motion of the sail car. In one embodiment, the electric cable retractor contains an angular displacement sensor (not shown). This sensor may be used to track the position of sail car 148.

### FIG. 4B—Description of a Transmission

In one embodiment, mostly shown in FIG. 4B, transmission 156 comprises drive pulley 82, opposing idler pulley 84 (shown in FIG. 4A), a two way translation to one way rotation converter 88b, spring loaded tensioner 86, flywheel shaft 89, flywheel 90, and a frame 159. Flexible transmission member 80 allows for power to be transmitted from sail car 14 to transmission 156.

### FIG. 4D

Tensioner 86 applies a force to member 80 to keep it taught around pulleys 82 and 84 while it is driven by sail car 148. Flywheel shaft 89 is coupled to flywheel 90 at one end and to electric generator 18 at the other end. The motion of sail car 14 may be intermittent at times due to changes in the speed of current C, the sail car pivoting and changing direction, adjustments made to the sail car, etc. Flywheel 90 sufficiently reduces this inherent intermittency to provide a substantially constant rate of rotation to electric generator 18.

### FIG. 4A

Referring back to FIG. 4A, pulley 84 is rotatably mounted on a substantially vertical shaft 85, which is in turn mounted to end frame 152 such that member 80 is substantially parallel to guides 26a.

### FIG. 4B, FIG. 4D, and FIG. 4E—Description of a Two Way Translation to One Way Rotation Converter

FIG. 4D

In one embodiment, shown in detail in FIG. 4B, FIG. 4D, and FIG. 4E, two way translation to one way rotation converter 88b comprises shaft 92 which is concentric about flywheel shaft 89, one way clutches 96, 98, pillow block supports 104 and 106, two flexible members 162 and 164 (FIG. 4B), two guides 166 and 168(FIG. 4B), two gripping levers 170 and 172 (FIG. 4B and FIG. 4E), two springs 174 and 176 (FIG. 4B and FIG. 4E), and two stops 178 and 180 (FIG. 4B and FIG. 4E). Shaft 92 houses clutches 96 and 98 and is rotatably journaled at its ends to supports 104 and 106. Pulley 82 is fixed near the middle of shaft 92. The part of converter 88b shown in FIG. 4D thusly allows power to be transmitted from sail car 148 to the flywheel without allowing power to be transmitted from the flywheel back to sail car 148.

### FIG. 4C

In one embodiment, shown in FIG. 4C, flexible members 162 and 164 of suitably chosen lengths are each fixed at one end to suitable positions along boom 42, strung through one of two guides 166 and 168, and are fixed at their other ends to one of two gripping levers 170 and 172, respectively. In one embodiment, members 162 and 164 are braided steel cable, but they may be made of any sufficiently durable flexible material such as nylon rope, steel or aluminum solid or braided cable(s), any type of line, any type of natural or synthetic fibrous solid or braided rope(s), any type of belt(s) (reinforced or not), any type of fabric(s), and the like.

As can be clearly seen from FIG. 4C, guide 166 guides member 162 slightly out of the page, while guide 168 guides member 164 slightly into the page. As can be seen in FIG. 4B, this difference in position causes member 162 to be loose and member 164 to be taught while sail 52 is in its current position. Once sail 52 pivots, member 162 will be taught and member 164 will be loose.

### FIG. 4E

In one embodiment, shown in FIG. 4C and in detail in FIG. 4E, levers 170 and 172 are rotatably supported to the base 34 of car frame 30. The axis of rotation for each lever is substantially parallel to member 80. Springs 174 and 176 are attached to the inner faces of levers 170 and 172, respectively, at one end and to stops 178 and 180 at their other ends. As shown in FIG. 4E, pulling member 164 taught causes lever 172 and stop 180 to grip member 80 between them. Since member 162 is loose, spring 174 causes lever 170 to release member 80. Arrows 182 show the motion of levers 170 and 172 after sail 52 pivots. Lever 170 grips member 80 when boom 42 is in a first angular position, whereas lever 172 grips member 80 when boom 42 is in a second angular position.

This arrangement allows sail car 148 to grip one of the two passes member 80 makes over sail car 148 when it is moving in one direction, and it allows sail car 148 to grip the other pass of member 80 when it is moving in the other direction. This allows member 80 to rotate pulley 82 with the same rotational sense regardless of the direction of motion of sail car 148.

### Operation FIG. 4A-FIG. 4E

Operation is similar to that of embodiments described in FIG. 1A-FIG. 1O.

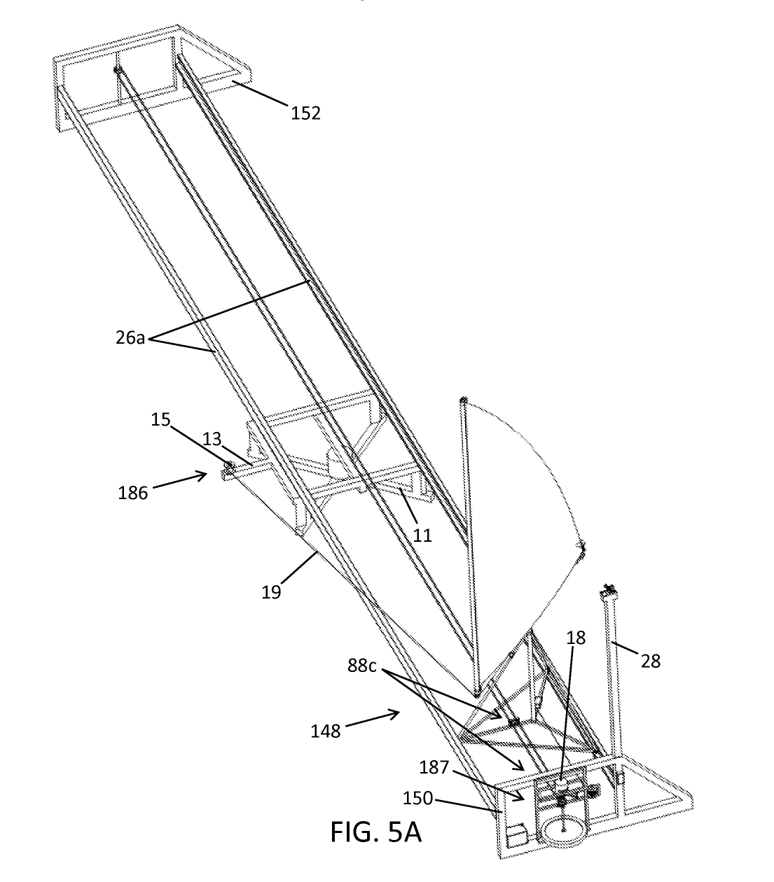

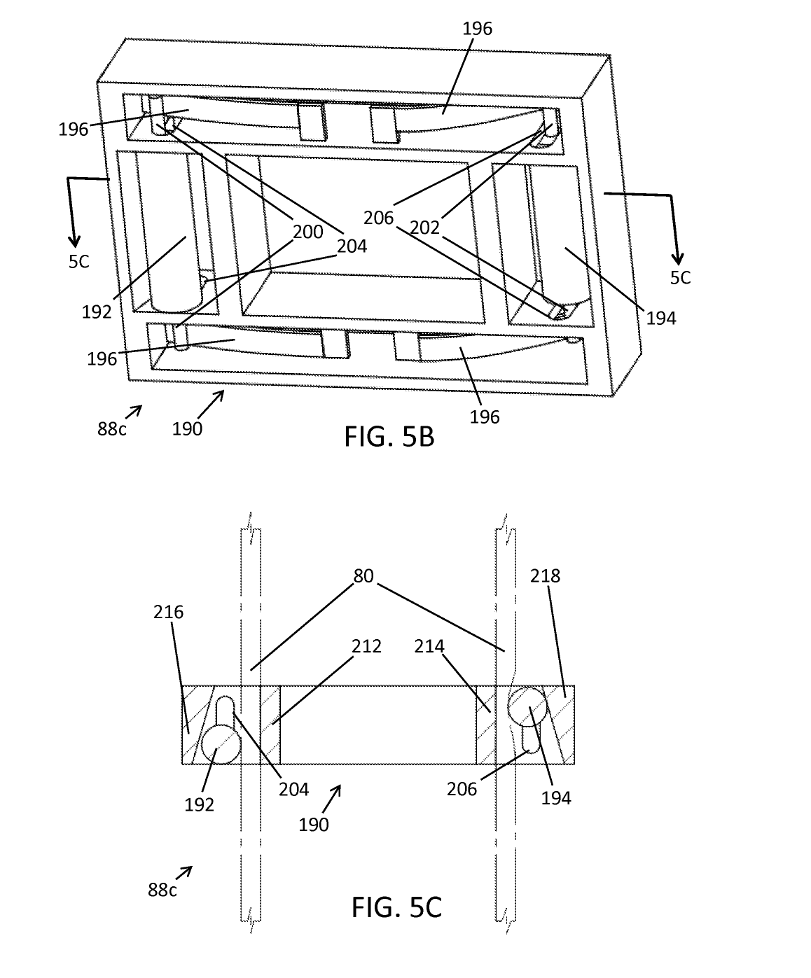

### FIG. 5A—Perspective View of a Wind or Water Powered Generator

One embodiment, shown in FIG. 5A, of the fundamental wind or water generator concept comprises a sail car 148, end frames 150 and 152, substantially parallel guides 26z, angle reversal frame 186, instrument pole 28, transmission 187, and electric generator 18.

Angle reversal frame 186 comprises base 11, beam 13, coil spring type recoiling spool 15, and flexible taught member 19. The base is fixed to the undersides of guides 26 near their midpoint lengthwise. Beam 13 extends horizontally upwind/upstream and is substantially perpendicular to guides 26a. Spool 15 is rotatably mounted near the end of beam 13 and is connected to member 19. In one embodiment, an eye bolt (not shown) is mounted vertically to beam 13 at a suitable height in front of spool 15 to guide member 19.

Transmission 187 comprises an identical structure and connectivity as transmission 156 except that two way translation to one way rotation converter 88b has been replaced by two way translation to one way rotation converter 88c.

### FIG. 5B and FIG. 5C—Description of a Two Way Translation to One Way Rotation Converter

### FIG. 5B

In one embodiment, shown in FIG. 5B and FIG. 5C, two way translation to one way rotation converter 88c comprises an identical structure and connectivity as two way translation to one way rotation converter 88b, except that flexible members 162 and 164, guides 166 and 168, levers 170 and 172, springs 174 and 176, and stops 178 and 180 have been replaced by a housing 190, two gripping rollers 192 and 194, and two disengaging spring elements 196 and 198. Rollers 192 and 194 are slidably constrained by two pairs of cylindrical protrusions 200 and 202 at their ends to two pairs of substantially parallel and horizontal slots 204 and 206 in housing 190, respectively. Member 80, shown as phantom lines in FIG. 5C, is strung through the housing between inner walls 208 and 210 and rollers 192 and 194 as shown. Protrusions 200 and 202 are rotatably mounted near the ends of spring elements 196 and 198, respectively. The spring elements encourage rollers 192 and 194 to release member 80 when appropriate.

### FIG. 5C

In one embodiment, shown in FIG. 5C, the cross section of housing 190 comprises inner rectangular walls 212 and 214 and outer wedge shaped walls 216 and 218. When one of the passes of member 80 moves towards the narrow end of one of the wedges, the adjacent roller spins freely, but when it moves towards the wider end of one of the wedges, it causes the adjacent roller to catch on the wedge and move with the belt until the roller grips the belt between itself and the adjacent rectangular wall. In FIG. 5C, roller 194 has caught on wedge 218, moved towards the wider part of the wedge, deformed spring element 198, and is now gripping member 80 between itself and rectangular wall 214 while roller 192 spins freely.

Converter 88c thusly allows sail car 184 to grip one of the two passes member 80 makes over the sail car when it is moving in one direction, and it allows the sail car to grip the other pass of member 80 when it is moving in the other direction. This allows member 80 to rotate pulley 82 with the same rotational sense regardless of the direction of motion of sail car 184.

### Operation FIG. 5A-FIG. 5C

Operation is similar to that of embodiments described in FIG. 1A-FIG. 1O, except that it cannot adjust to changing flow direction.

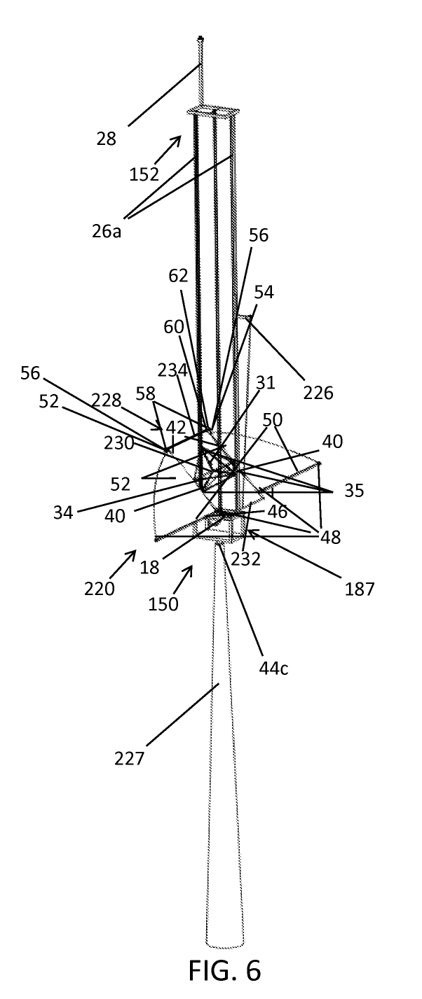

### FIG. 6

One embodiment, shown in FIG. 6, of the fundamental wind or water generator concept comprises a sail car 220, end frames 150 and 152, substantially parallel guides 26a, an angle reversal frame 226, instrument pole 28, transmission 187, electric generator 18, an electromechanical flow aligner 44c, and a tower 227.

In one embodiment, shown in FIG. 6, sail car 220 comprises the following parts that maintain identical function in FIG. 1A and FIG. 1B: car frame 228, mast axle 230, wheels 35, car electrical box 31, one or more damper(s) 40, booms 42, masts 46, sail recoiler(s) 48, luff extrusion(s) 50, sail coupling(s) 232, sails 52, members 54, furling spools 58, furling spool coupling 234, sail cringles 56, furling motor 60, and furling disc lock 62. These parts maintain similar functionality to those in FIG. 5A except that car frame 228 comprises additional structural members to support the following: one end of mast axle 230, a second damper 40, a second boom 42, a second mast 46, one or more additional sail recoiler(s) 48, a second luff extrusion 50, one end of one or more sail coupling(s) 232, a second member 54, a second furling spool 58, one end of furling spool coupling 234, and a second sail cringle 56. These additional components allow a second sail 52 to be mounted in a position which mirrors a first sail 52 about a plane defined by base 34. This second sail 52 increases the force applied by the oncoming flow and reduces the moment applied to the wind or water powered generator by balancing the applied forces.

In one embodiment, mast axle 230 is rotatably mounted to car frame 228 and is fixed on one end to one boom 42 and is fixed on its other end to a second boom 42, thus coupling the rotational motion of sails 52.

In one embodiment, sail coupling(s) 232 is (are) mounted substantially perpendicularly to booms 42 in order to add structural support and rigidity to this coupling. One or more coupling(s) 232 may be mounted in (a) suitable location(s) along booms 42 as long as it (they) does (do) not interfere with any components during the pitch reversal or translation of sails 52.

In one embodiment, furling spool coupling 234 is rotatably mounted to booms 42 near their downstream ends and is fixed at some point along its length to furling motor 60 and to disc 49 (See FIG. 1C) of furling disc lock 62. The housing of furling motor 60 and casing 41 (See FIG. 1C) of furling disc lock 62 is fixed to one of the booms 42 or to an adjacent coupling 232. Furling spool coupling 234 thusly synchronizes the furling and unfurling of sails 52 in order to maintain balanced forces during operation.

In one embodiment, angle reversal frame 226 is similar to angle reversal frame 186, except that it does not touch the ground and it is mounted such that it does not interfere with any translating components (i.e. sail car 220) during operation.

In one embodiment, shown in FIG. 6, electromechanical flow aligner 44c uses any suitable electromechanical means to rotate end frame 150 such that sails 52 are pointed into the flow direction.

In one embodiment, shown in FIG. 6, tower 227 provides elevation to allow for access to a stronger current.

### Operation FIG. 6

Operation is similar to that of embodiments described in FIG. 1A-FIG. 1O, except that adjustment to flow direction occurs about an axis parallel to the direction of translation of sail car 220.

### CONCLUSIONS, RAMIFICATIONS, AND SCOPE

Replacement Components

Linear guide(s) 26a and 26b, electromechanical flow aligner 44a, 44b, and 44c, and two way translation to one way rotation converter 88a, 88b, and 88c may replace other linear guide(s), electromechanical flow aligners, and two way translation to one way rotation converters, respectively, in any embodiments described, where such a replacement is suitable.

Some embodiments (not shown) of the fundamental wind or water generator concept comprise an identical structure and functionality as an embodiment of the fundamental wind or water generator concept described in the sections of the description with titles FIG. 1A-FIG. 1O, except that: (a) linear guide(s) 26a have been replaced by linear guide(s) 26b and/or (b) electromechanical flow aligner 44a has been replaced by electromechanical flow aligner 44b and/or (c) two way translation to one way rotation converter 88a has been replaced by two way translation to one way rotation converter 88b or two way translation to one way rotation converter 88c.

Some embodiments (not shown) of the fundamental wind or water generator concept comprise an identical structure and functionality as an embodiment of the fundamental wind or water generator concept described in the sections of the description with titles FIG. 2A-FIG. 2B, except that: (a) linear guide(s) 26a have been replaced by linear guide(s) 26b and/or (b) electromechanical flow aligner 44a has been replaced by electromechanical flow aligner 44b and/or (c) two way translation to one way rotation converter 88a has been replaced by two way translation to one way rotation converter 88b or two way translation to one way rotation converter 88c.

Some embodiments (not shown) of the fundamental wind or water generator concept comprise an identical structure and functionality as an embodiment of the fundamental wind or water generator concept described in the section of the description with the title FIG. 3, except that: (a) linear guide(s) 26b have been replaced by linear guide(s) 26a and/or (b) electromechanical flow aligner 44a has been replaced by electromechanical flow aligner 44b and/or (c) two way translation to one way rotation converter 88a has been replaced by two way translation to one way rotation converter 88b or two way translation to one way rotation converter 88c.

Some embodiments (not shown) of the fundamental wind or water generator concept comprise an identical structure and functionality as an embodiment of the fundamental wind or water generator concept described in the sections of the description with titles FIG. 4A-FIG. 4E, except that: (a) linear guide(s) 26a have been replaced by linear guide(s) 26b and/or (b) electromechanical flow aligner 44b has been replaced by electromechanical flow aligner 44a and/or (c) two way translation to one way rotation converter 88b has been replaced by two way translation to one way rotation converter 88a or two way translation to one way rotation converter 88c.

Some embodiments (not shown) of the fundamental wind or water generator concept comprise an identical structure and functionality as an embodiment of the fundamental wind or water generator concept described in the sections of the description with titles FIG. 5A-FIG. 5C, except that: (a) linear guide(s) 26a have been replaced by linear guide(s) 26b and/or (b) electromechanical flow aligner 44a or electromechanical flow aligner 44b is implemented and/or (c) two way translation to one way rotation converter 88c has been replaced by two way translation to one way rotation converter 88a or two way translation to one way rotation converter 88b.

Some embodiments (not shown) of the fundamental wind or water generator concept comprise an identical structure and functionality as an embodiment of the fundamental wind or water generator concept described in the sections of the description titled FIG. 6, except that: (a) linear guide(s) 26a have been replaced by linear guide(s) 26b and/or (b) electromechanical flow aligner 44c has been replaced by electromechanical flow aligner 44a or electromechanical flow aligner 44b and/or (c) two way translation to one way rotation converter 88c has been replaced by two way translation to one way rotation converter 88a or two way translation to one way rotation converter 88b.

This disclosure includes a new way to harness energy from wind or water current and convert it into another form.

Accordingly, advantages of one or more aspects are as follows: to provide power conversion apparatuses that are more cost efficient, that may be placed closer together without a significant loss of performance, that operate more quietly, that are more visually appealing, that are easier to manufacture, that can readily adapt to changing wind or water direction, and that can readily adapt to rapidly changing wind or water current speeds. Other advantages of one or more aspects are apparent from a consideration of the drawings and description.

While the present disclosure may be susceptible to embodiment in different forms, the figures show, and herein described in detail, embodiments with the understanding that the present descriptions are to be considered exemplifications of the principles of the disclosure and are not intended to be exhaustive or to limit the disclosure to the details of construction and the arrangements of components set forth in the description or illustrated in the figures.

I claim:

1. A device for harnessing energy from wind or water current and converting it into another form.

2. A method for converting energy from wind or water current into another form.
